(19) United States
(12) Patent Application Publication
(10) Pub. No.: US 2023/0289560 A1
(43) Pub. Date: Sep. 14, 2023

(54) MACHINE LEARNING TECHNIQUES TO PREDICT CONTENT ACTIONS

(71) Applicants: Weizhi Li, Freemont, CA (US); Vineet Abhishek, San Mateo, CA (US); Jason Brewer, Marina del Rey, CA (US); Roman Grachev, Burlingame, CA (US); Rui Zhang, San Francisco, CA (US)

(72) Inventors: Weizhi Li, Freemont, CA (US); Vineet Abhishek, San Mateo, CA (US); Jason Brewer, Marina del Rey, CA (US); Roman Grachev, Burlingame, CA (US); Rui Zhang, San Francisco, CA (US)

(21) Appl. No.: 17/694,463

(22) Filed: Mar. 14, 2022

(51) Int. Cl. G06N 3/04; G06N 3/08

(52) U.S. Cl. CPC G06N 3/0454; G06N 3/08

(57) ABSTRACT

Machine learning architectures may predict the likelihood of interaction by users with content items that are accessible using a client application. The machine learning architectures may include one or more feature interaction layers that are coupled with one or more extraction layers. Content items may be selected to provide to users of the client application based on probabilities of users performing one or more actions with respect to the content items, where the probabilities for each action are determined by the machine learning architectures.

### BACKGROUND

Applications executed by client devices may be used to generate content. For example, client applications may be used to generate messaging content, image content, video content, audio content, media overlays, documents, creative works, combinations thereof, and the like. In a number situations, users of client applications may perform various actions with respect to the content that is accessible using the client applications.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some implementations are illustrated by way of example, and not limitation.

FIG. 1 is a diagrammatic representation of an architecture for exchanging data (e.g., messages and associated content) over a network, according to one or more example implementations.

FIG. 2 is a diagrammatic representation of a system, in accordance with some examples, that may have both client-side and server-side functionality.

FIG. 3 is a schematic diagram illustrating data that may be stored in a database of a server system, according to one or more example implementations.

FIG. 4 is a schematic diagram illustrating an example framework for content that may be generated by a client application, in accordance with one or more example implementations.

FIG. 5 is a diagrammatic representation illustrating an environment that includes machine learning architectures that are related to respective content action groups and that generate predicted actions for users in relation to content based on input data corresponding to the users, in accordance with one or more example implementations.

FIG. 6 is a diagrammatic representation illustrative of an environment that includes a machine learning architecture having a feature interaction layer coupled with one or more computational experts layers to generate predictions indicating actions users may perform with respect to one or more content items, in accordance with one or more example implementations.

FIG. 7 is a flowchart illustrating example operations of a process to implement one or more machine learning architectures to determine probabilities of users performing actions with respect to content accessible using a client application, according to one or more example implementations.

FIG. 8 is a block diagram illustrating components of a machine, in the form of a computer system, that may read and execute instructions from one or more machine-readable media to perform any one or more methodologies described herein, in accordance with one or more example implementations.

FIG. 9 is block diagram illustrating a representative software architecture that may be used in conjunction with one or more hardware architectures described herein, in accordance with one or more example implementations.

### DETAILED DESCRIPTION

Users of client applications may perform a number of actions with respect to content that is accessible via the client applications. For example, users of client applications may access at least one of video content, text content, or audio content via client applications. To illustrate, users may access social networking information using client applications. In one or more illustrative examples, users may access messages, social network posts, stories, videos, and the like via client applications. Augmented reality content may also be accessed using client applications. In at least some scenarios, advertising content may be accessed by users of client applications.

In various examples, users can perform one or more actions with respect to content that is accessible using client applications. In one or more examples, users may cause at least one of video content or audio content to play within a client application. Content may also be shared between users of client applications. In one or more additional examples, users may provide comments or annotations with regard to content accessed via a client application. In one or more further examples, items may be purchased using a client application. The items may be related to content that is accessible using the client application.

In one or more implementations, the actions that may be performed with respect to content may be specified by one or more entities. For example, a creator of content that is accessible via a client application may specify actions that may be performed with respect to content that is produced by the creator. Additionally, an entity that at least one of creates, maintains, or distributes a client application or client application platform may specify actions that may be performed by users of the client application or client application platform. In various examples, the actions performed in relation to content accessible via a client application may be monitored. In this way, providers of content, creators of content, or both may be able to identify actions that users perform with respect to their content. In at least some examples, at least one of providers of content or creators of content may identify characteristics of users of client applications that perform one or more actions with respect to the content associated with the providers or creators.

In one or more illustrative examples, advertising content may be accessible via a client application. The advertising content may include at least one of video content, audio content, or text content. In one or more examples the advertising content may be provided in association with content items that are accessible using the client application. For example, the advertising content may be provided with respect to message content accessible using the client application. In one or more additional examples the advertising content may be provided with respect to social networking content accessible via the client application. In one or more further examples the advertising content may be provided in association with augmented reality content accessible using the client application.

A number of actions may be performed by users of a client application with respect to advertising content. The actions may include views of the advertising content, an amount of time the advertising content is viewed, purchases of items in response to accessing the advertising content, adding one or more items to a cart of a user for future purchase in response to accessing the advertising content, signing up for an account and/or a service that is related to the advertising content, one or more combinations thereof, and the like.

In various examples, the advertising content may be related to an additional client application that is different from the client application that is making the advertising content accessible to users. The client application may be an additional application that is executable from within the client application. In at least some of these situations, the additional client application may provide functionality that is complementary to the functionality of the client application. The additional client application may also be executable separately from the client application. In at least some of these scenarios, the additional client application may have functionality that is different from functionality of the client application. The actions that may be performed by a user in relation to the additional client application and in response to the advertising content may include signing up for an account related to the additional client application, adding the client application to a cart for future purchase, and purchasing the additional client application.

In existing systems, user interaction with content items is typically limited. That is, the percentage of users performing actions with respect to a content item is relatively low in relation to the number of users of the client application that have access to the content item. Often, content items provided to users are not of interest to the users. As a result, the use of network resources and computing resources is inefficient because memory resources, processing resources, power resources, financial resources, and network bandwidth resources are used to provide content that is not of interest to users.

Providers of content and/or creators of content may implement one or more computational techniques to identify content items that users are more likely to interact with. In one or more examples, characteristics of users of client applications that previously interacted with one or more content items may be analyzed. In this way, for a given content item characteristics of additional users may be analyzed in relation to characteristics of users that previously interacted with the same or similar content item to determine a probability of the additional users interacting with the given content item. In various instances, multiple actions may be performed with respect to the given content item and characteristics of previous users may be analyzed to determine probabilities of additional users performing individual actions that correspond to the given content item.

However, typical computational techniques are unable to accurately predict content items that will result in users performing one or more actions in relation to the content items. Thus, computing, memory, and network resources continue to be inefficiently utilized even when these computational techniques are implemented. Further, typical computational techniques are inefficient and result in latency during the use of a client application. That is, while the computations are taking place to identify content items that a user may interact with, the performance of the client application making the content items accessible may be reduced resulting in a lag, pause, or freeze of the client application.

The systems, methods, techniques, instruction sequences, and computing machine program products described herein are directed to determining groups of content actions that are related and computational models that are executable to determine probabilities of users of a client application performing the respective actions for given content items. Machine learning architectures may be trained with respect to the different groups of content actions such that a first machine learning architecture may be executed with respect to a first group of content actions and a second machine learning architecture may be executed with respect to a second group of content actions. The machine learning architectures may include the same or similar components, but may have different parameters, weights, coefficients, and the like due to the individual machine learning architectures being trained using different training data sets. In one or more illustrative examples, the machine learning architectures may include a feature interaction layer that is coupled with multiple extraction layers. Individual extraction layers may include a number of computational experts models and one or more gating networks that analyze the output from the computational experts models.

In one or more examples, training data may be obtained for a group of content actions. The training data may include characteristics of users of a client application that performed at least one of the content actions in the group of content actions with respect to one or more content items. A machine learning architecture that includes a feature interaction layer and a multi-level extraction layer may undergo a training process until one or more loss functions of the machine learning architecture are minimized. After the training process for the machine learning architecture is completed, a user of the client application may be identified, and the characteristics of the user may be analyzed using the machine learning architecture. In various examples, profile data of the user may be analyzed by the machine learning architecture to determine probabilities of the user performing individual actions included in the group of content interactions. In one or more illustrative examples, the profile data of the user may be analyzed with respect to the group of content actions for multiple content items. A content item having a greatest probability of one or more of the content actions may be determined and the content item may be made accessible to the user via the client application. In this way, users of the client application may be provided with content items that are of interest to the users.

In one or more illustrative examples, a group of content actions may correspond to actions that may be performed with regard to advertising content accessible via the client application. In these scenarios, the group of content actions may include viewing a page related to an item associated with the advertising content, adding an item related to the advertising content to a cart of the user for a potential future purchase, purchasing the item related to the advertising content, and signing up for an account corresponding to an item available for purchase in relation to the advertising content. The machine learning architecture may analyze the profile data of the user to determine a probability of the user performing the actions included in the group of content actions for a number of advertising content items. The machine learning architecture may determine an advertising content item that the user is most likely to interact with or identify an advertising content item for which the user is most likely to perform one or more of the group of content actions. The advertising content item may then be made accessible to the user via the client application.

The systems, methods, techniques, instruction sequences, and computing machine program products described herein are directed to a machine learning architecture that more accurately predicts actions that users may perform with respect to content items. In this way, the use of computing resources, memory resources, financial resources, and networking resources is optimized in providing content items to users of client applications. Additionally, the use of the feature interaction layer coupled with the multi-level extraction layer results in the predictions made by the machine learning architecture to be made more efficiently and in less time than conventional systems. As a result, any latency, delay, or lag that may result from the computations performed by the machine learning architectures are minimized and not recognizable by user in contrast to conventional systems.

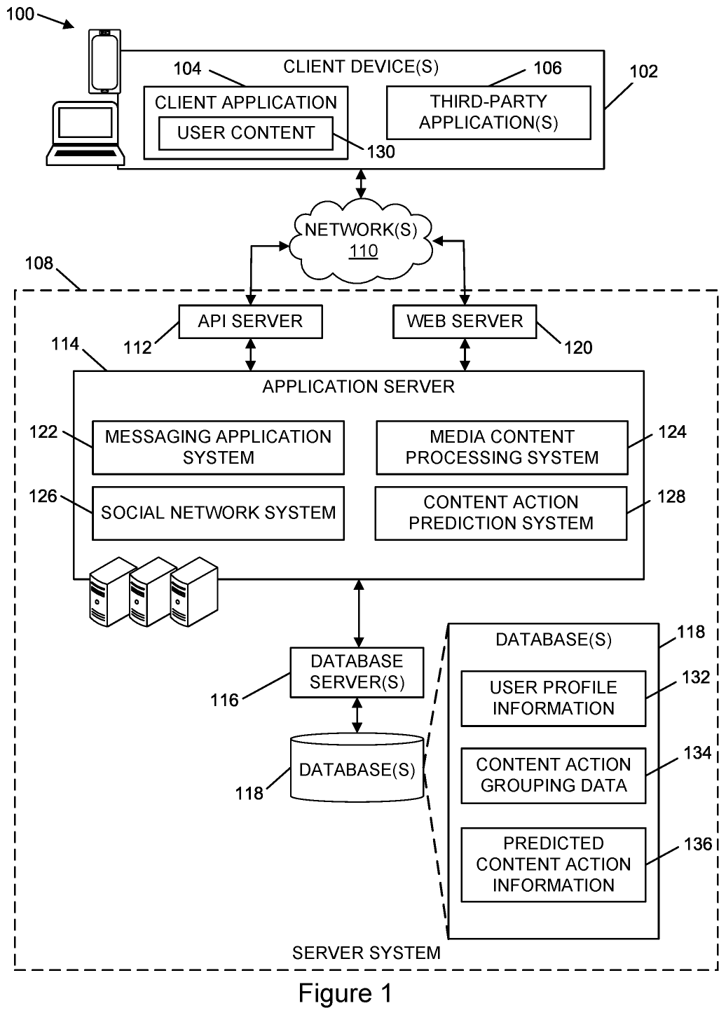

FIG. 1 is a diagrammatic representation of an architecture 100 for exchanging data (e.g., messages and associated content) over a network. The architecture 100 may include multiple client devices 102. The client devices 102 may individually comprise, but are not limited to, a mobile phone, a desktop computer, a laptop computing device, a portable digital assistant (PDA), smart phone, tablet computing device, ultrabook, netbook, multi-processor system, microprocessor-based or programmable consumer electronic system, game console, set-top box, computer in a vehicle, a wearable device, one or more combinations thereof, or any other communication device that a user may utilize to access one or more components included in the architecture 100.

Each client device 102 may host a number of applications, including a client application 104 and one or more third-party applications 106. A user may use the client application 104 to create content, such as video, images (e.g., photographs), audio, and media overlays. In one or more illustrative examples, the client application 104 may include a social networking functionality that enables users to create and exchange content. In various examples, the client application 104 may include messaging functionality that may be used to send messages between instances of the client application 104 executed by various client devices 102. The messages created using the client application 104 may include video, one or more images, audio, media overlays, text, content produced using one or more creative tools, annotations, and the like. In one or more implementations, the client application 104 may be used to view and generate interactive messages, view locations of other users of the client application 104 on a map, chat with other users of the client application 104, and so forth.

One or more users may be a person, a machine, or other means of interacting with a client device, such as the client device 102. In example implementations, the user may not be part of the architecture 100 but may interact with one or more components of the architecture 100 via a client device 102 or other means. In various examples, users may provide input (e.g., touch screen input or alphanumeric input) to a client device 102 and the input may be communicated to other entities in the architecture 100. In this instance, the other entities in the architecture 100, responsive to the user input, may communicate information to a client device 102 to be presented to the users. In this way, users may interact with the various entities in the architecture 100 using the client device 102.

Each instance of the client application 104 is able to communicate and exchange data with at least one of another instance of the client application 104, one or more third-party applications 106, or a server system 108. The data exchanged between instances of the client applications 104, between the third-party applications 106, and between instances of the client application 104 and the server system 108 includes functions (e.g., commands to invoke functions) and payload data (e.g., text, audio, image, video, or other multimedia data). Data exchanged between instances of the client applications 104, between the third-party applications 106, and between at least one instance of the client application 104 and at least one third-party application 106 may be exchanged directly from an instance of an application executed by a client device 102 and an instance of an application executed by an additional client device 102. Further, data exchanged between the client applications 104, between the third-party applications 106, and between at least one client application 104 and at least one third-party application 106 may be communicated indirectly (e.g., via one or more intermediate servers) from an instance of an application executed by a client device 102 to another instance of an application executed by an additional client device 102. In one or more illustrative examples, the one or more intermediate servers used in indirect communications between applications may be included in the server system 108.

The third-party application(s) 106 may be separate and distinct from the client application 104. The third-party application(s) 106 may be downloaded and installed by the client device 102 separately from the client application 104. In various implementations, the third-party application(s) 106 may be downloaded and installed by the client device 102 before or after the client application 104 is downloaded and installed. The third-party application(s) 106 may be an application that is provided by an entity or organization that is different from the entity or organization that provides the client application 104. The third-party application(s) 106 may be accessed by the client device 102 using separate login credentials than the client application 104. Namely, the third-party application(s) 106 may maintain a first user account and the client application 104 may maintain a second user account. In one or more implementations, the third-party application(s) 106 may be accessed by the client device 102 to perform various activities and interactions, such as listening to music, videos, track exercises, view graphical elements (e.g., stickers), communicate with other users, and so forth. As an example, the third-party application(s) 106 may include a social networking application, a dating application, a ride or car sharing application, a shopping application, a trading application, a gaming application, an imaging application, a music application, a video browsing application, an exercise tracking application, a health monitoring application, a graphical element or sticker browsing application, or any other suitable application.

The server system 108 provides server-side functionality via one or more networks 110 to the client application 104. The server system 108 may be a cloud computing environment, according to some example implementations. For example, the server system 108, and one or more servers associated with the server system 108, may be associated with a cloud-based application, in one illustrative example. In one or more implementations, the client device 102 and the server system 108 may be coupled via the one or more networks 110.

The server system 108 supports various services and operations that are provided to the client application 104. Such operations include transmitting data to, receiving data from, and processing data generated by the client application 104. This data may include message content, media content, client device information, geolocation information, media annotation and overlays, message content persistence conditions, social network information, and live event information, as examples. Data exchanges within the architecture 100 are invoked and controlled through functions available via user interfaces (UIs) of the client application 104.

While certain functions of the architecture 100 are described herein as being performed by either a client application 104 or by the server system 108, the location of functionality either within the client application 104 or the server system 108 is a design choice. For example, it may be technically preferable to initially deploy certain technology and functionality within the server system 108, but to later migrate this technology and functionality to the client application 104 where a client device 102 has a sufficient processing capacity.

The server system 108 includes an Application Programming Interface (API) server 112 that is coupled to, and provides a programmatic interface to, an application server 114. The application server 114 is communicatively coupled to a database server 116 that facilitates access to one or more databases 118. The one or more databases 118 may store data associated with information processed by the application server 114. The one or more databases 118 may be storage devices that store information such as untreated media content, original media content from users (e.g., high-quality media content), processed media content (e.g., media content that is formatted for sharing with client devices 102 and viewing on client devices 102), context data related to a media content item, context data related to a user device (e.g., a computing or client device 102), media overlays, media overlay smart widgets or smart elements, user data, user device information, media content (e.g., video and images), media content data (e.g., data associated with video and images), computing device context data, serialized data, session data items, user device location data, mapping information, interactive message usage data, interactive message metrics data, and so forth. The one or more databases 118 may further store information related to third-party servers, client devices 102, client applications 104, users, third-party applications 106, and so forth.

The API server 112 receives and transmits data (e.g., commands and message payloads) between client devices 102 and the application server 114. Specifically, the Application Program Interface (API) server 112 provides a set of interfaces (e.g., routines and protocols) that can be called or queried by the client application 104 in order to invoke functionality of the application server 114. The Application Program Interface (API) server 112 exposes various functions supported by the application server 114, including account registration, login functionality, the sending of messages, via the application server 114, from one instance of the client application 104 to another instance of the client application 104, the sending of media files (e.g., images, audio, video) from a client application 104 to the application server 114, and for possible access by another client application 104, the setting of a collection of media content (e.g., a gallery, story, message collection, or media collection), the retrieval of a list of friends of a user of a client device 102, the retrieval of such collections, the retrieval of messages and content, the adding and deletion of friends to a social graph, the location of friends within a social graph, and opening an application event (e.g., relating to the client application 104).

The server system 108 may also include a web server 120. The web server 120 is coupled to the application servers 114 and provides web-based interfaces to the application servers 114. To this end, the web server 120 processes incoming network requests over the Hypertext Transfer Protocol (HTTP) and several other related protocols.

The application server 114 hosts a number of applications and subsystems, including a messaging application system 122, a media content processing system 124, a social network system 126, and a content action prediction system 128. The messaging application system 122 implements a number of message processing technologies and functions, particularly related to the aggregation and other processing of content (e.g., textual and multimedia content) included in messages received from multiple instances of the client application 104. For example, the messaging application system 122 may deliver messages using electronic mail (email), instant messaging (IM), Short Message Service (SMS), text, facsimile, or voice (e.g., Voice over IP (VoIP)) messages via wired networks (e.g., the Internet), plain old telephone service (POTS), or wireless networks (e.g., mobile, cellular, WIFI, Long Term Evolution (LTE), or Bluetooth). The messaging application system 122 may aggregate text and media content from multiple sources into collections of content. These collections are then made available, by the messaging application system 122, to the client application 104. Other processor- and memory-intensive processing of data may also be performed server-side by the messaging application system 122, in view of the hardware requirements for such processing.

The media content processing system 124 is dedicated to performing various media content processing operations, typically with respect to images, audio, or video received within the payload of a message or other content item at the messaging application system 122. The media content processing system 124 may access one or more data storages (e.g., the database(s) 118) to retrieve stored data to use in processing media content and to store results of processed media content.

The social network system 126 supports various social networking functions and services and makes these functions and services available to the messaging application system 122. To this end, the social network system 126 maintains and accesses an entity graph within the database(s) 118. Examples of functions and services supported by the social network system 126 include the identification of other users of the client application 104 with which a particular user has relationships or is “following”, and also the identification of other entities and interests of a particular user. The social network system 126 may access location information associated with each of the user's friends or other social network connections to determine where they live or are currently located geographically. In addition, the social network system 126 may maintain a location profile for each of the user's friends indicating the geographical location where the user's friends live.

The content action prediction system 128 may determine probabilities of users performing actions with respect to content items that are accessible via the client application 104. In one or more examples, the content items may include user content 130. The user content 130 may be generated by one or more users of the client application 104. The user content 130 may include at least one of image content, video content, text content, or augmented reality content that is accessible using the client application 104. In various examples, the user content 130 may be captured by one or more input devices of a client device 102, such as one or more cameras or one or more microphones of the client device 102. In one or more examples, the user content 130 may include a live camera view captured by one or more cameras of the client device 102. In one or more additional examples, the user content 130 may include content previously captured by one or more input devices of a client device 102. For example, the user content 130 may have been previously captured by one or more input devices of the client device 102 and stored in memory accessible to the client device 102. The memory may be included within a housing of the client device 102 or located remotely with respect to the client device 102. In situations where the memory storing the user content 130 is located remotely with respect to the client device 102, the memory may be accessible to the client device 102 via the one or more networks 110. To illustrate, the user content 130 may be stored in one or more cloud-based storage devices that are accessible to the client device 102 via the one or more networks 110. In one or more illustrative examples, the user content 130 may be stored by the one or more databases 118. In one or more additional examples, the actions may be performed in relation to advertising content that is accessible via the client application 104. In one or more further examples, the actions may be performed in relation to advertising content that is accessible in relation to user content 130. For example, as users of the client application 104 access one or more content items that are included in the user content 130, one or more advertising content items may also be displayed or otherwise accessible to the users of the client application 104.

The content action prediction system 128 may execute one or more machine learning architectures to determining probabilities of users of the client application 104 performing one or more actions with respect to one or more content items. The one or more machine learning architectures may include a feature extraction layer. In one or ore illustrative examples, the feature extraction layer may include a deep and cross network model. Additionally, the content action prediction system 128 may include one or more extraction layers. Individual extraction layers may include a number of computational experts models. The computational experts models included in the individual extraction layers may include one or more computational experts models that correspond to a given action being predicted. For example, an individual extraction layer may include a first set of computational experts models for a first task that is being predicted by the machine learning architecture and a second set of computational experts models for a second task that is being predicted by the machine learning architecture. The individual extraction layers may also include one or more shared computational experts models that correspond to the group of actions being predicted by the machine learning architecture. In various examples, the individual extraction layers may also include one or more gating networks. The one or more gating networks may analyze input from one or more of the computational experts models. In one or more illustrative examples, the one or more gating networks may include multiple softmax layers. The use of multiple softmax layers may balance the results obtained from the computational experts models in relation to existing systems. That is, in existing systems, as the output for computational experts models for a first task achieve improved accuracy, the output for computational experts models for a second task may decrease in accuracy. The use of multiple softmax functions in individual gating networks may result in improved balance of results provided by the computational experts models and result in improved accuracy of predictions made by the computational experts models corresponding to multiple tasks.

The content action prediction system 128 may analyze user profile information 132 stored by the one or more databases 118 to train the machine learning architectures of the content action prediction system 128. The user profile information 132 may include characteristics of users of the client application 104. The characteristics of the users included in the user profile information 132 may include usage history of the client application 104. For example, the user profile information 132 may indicate content that has been previously accessed by the users of the client application 104. The user profile information 132 may also indicate amounts of time that content was viewed by users of the client application 104. Additionally, the user profile information 132 may indicate location data related to users of the client application 104. Further, the user profile information 132 may include demographic information of users of the client application 104. The training of the machine learning architectures included in the content action prediction system 128 may determine characteristics of users of the client application 104 in relation to a likelihood of the users to take one or more actions with respect to at least one of one or more content items or one or more classifications of content items. The training of the machine learning architectures included in the content action prediction system 128 may determine at least one of parameters, weights, coefficients, or other components of one or more models of the machine learning architectures included in the content action prediction system 128.

In various examples, the machine learning architectures of the content action prediction system 128 may be trained using historical data obtained from users of the client application 104 that indicates users that previously performed one or more actions with respect a content item. For example, training data for the machine learning architectures of the content action prediction system 128 may indicate users that added an item to their cart in response to accessing an advertisement related to the item. The training data for the machine learning architectures of the content action prediction system 128 may also indicate users that viewed a page of an item included in the advertisement for the item or that purchased the item included in the advertisement. During the training process, characteristics of users that performed one or more actions may be analyzed to generate machine learning models of the content action prediction system 128 that predict the probability of additional users performing the actions based on the characteristics of the additional users.

The one or more databases 118 may also store content action grouping data 134. The content action grouping data 134 may indicate groups of actions that may be performed in relation to content accessible using the client application 104. The actions included in individual content action groupings may be correlated with one another. In one or more examples, the content action prediction system 128 may determine correlations between actions that may be performed with respect to content that is accessible using the client application 104 and group the actions based on a measure of correlation between the respective actions. In one or more additional examples, predetermined groupings of content actions may be obtained from at least one of content creators, content providers, or administrators of the server system 108. In one or more examples, the content action grouping data 134 may indicate a first group of content actions that are correlated with one another, a second group of content actions that are correlated with one another, and a third group of content actions that are correlated with one another. The use of groups of actions that are correlated with one another in relation to the content action prediction system 128 may reduce the presence of negative transfer that is present in existing systems.

In one or more illustrative examples, the content action grouping data 134 may group actions that may be performed with respect to advertising content. To illustrate, the content action grouping data 134 may include a first content action grouping that includes a page view related to an advertising content item, a purchase of an item that corresponds to the advertising content item, adding an item corresponding to an advertising content item to the cart of a user of the client application 104 for a potential purchase of the item, and a sign up by a user of the client application 104 in relation to an account, promotions, and the like related to items that correspond to the advertising content item. In one or more additional illustrative examples, the content action grouping data 134 may include a second content action grouping that is related to actions that may be performed with regard to additional client applications that may be obtained using the client application 104 or accessed within the client application 104. For example, the content action grouping data 134 can include a group of actions that correspond to purchase of an additional client application that corresponds to an advertising content item, adding an additional client application related to an advertising content item to the cart of a user for a potential future purchase, and a sign up in relation to an account associated with a client application 104 that is associated with an advertising content item.

Further, the content action grouping data 134 can include a third content action grouping that corresponds to video content. In at least some examples, the content action grouping data 134 can include a content action group that includes at least one of a content action related to viewing video content for at least two seconds, a content action related to viewing the video content for at least 5 seconds, a content action related to viewing the video content for at least 8 seconds, a content action related to viewing the video content for at least 10 seconds, a content action related to viewing the video content for at least 12 seconds, a content action related to viewing the video content for at least 15 seconds, a content action related to viewing the video content for at least 18 seconds, or a content action related to viewing the video content for at least 20 seconds. In various examples, the video content may comprise or otherwise be accessible in relation to advertising content.

In one or more examples, the content action prediction system 128 may include individual machine learning architectures that correspond to individual content action groupings. For example, the content action prediction system 128 may include a first machine learning architecture that is trained to determine probabilities of users of the client application 104 performing individual actions included in the first content action grouping and a second machine learning architecture that is trained to determine probabilities of users of the client application 104 performing individual actions included in the second content action grouping. In various examples, the content action prediction system 128 may include a machine learning architecture that is trained to determine probabilities of users of the client application 104 performing individual actions included in the third content action grouping.

In various examples, the one or more databases 118 may store predicted content action information 136. The predicted content action information 136 may include probabilities of users accessing content items that were previously determined by the content action prediction system 128. In one or more examples, the content action prediction system 128 may execute one or more machine learning architectures to determine probabilities of a group of users of the client application 104 performing one or more actions included in one or more content action groupings. In these scenarios, the content action prediction system 128 may cause content items to be accessible to a user of the client application 104 during use of the client application that correspond to at least a threshold probability of the user performing one or more actions related to the content item. In at least some situations, the predicted content action information 136 may be updated periodically, such as within a specified amount of time since a previous determination of content action probabilities by the content action prediction system 128 for a given user of the client application 104. The predicted content action information 136 may also be updated in response to users of the client application 104 initiating execution of new instances of the client application 104, such as opening the client application 104 using the client device 102.

In one or more illustrative examples, as a user of the client application 104 is navigating through content using the client application 104, the content action prediction system 128 may determine that the user has at least a threshold probability of performing one or more actions with respect to a content item. In these scenarios, the content action prediction system 128 may make the content item accessible to the user, such as by displaying the content item in a user interface of the client application 104 or providing a link to the content item. In one or more additional illustrative examples, a user of the client application 104 may be viewing or otherwise accessing content via the client application 104 and the content action prediction system 128 may determine that the content is associated with one or more additional content items, such as one or more advertisements. To illustrate, at least a portion of the content or classifications of content accessible via the client application 104 may be associated with one or more advertising items. The content action prediction system 128 may analyze user profile information 132 of the user to determine an advertising content item related to the content being viewed by the user. For example, a user may be viewing at least one of social networking content, message content, or other content accessible via the client application 104 and the content action prediction system 128 may determine that one or more advertisements correspond to the content being accessed by the user. The content action prediction system 128 may then determine probabilities of the user performing actions included in one or more groupings of content actions related to the advertisement with respect to the user. In various examples, the content action prediction system 128 may determine an advertisement associated with one or more actions that have at least a threshold probability of the user performing and cause the advertisement to be accessible to the user via the client application 104.

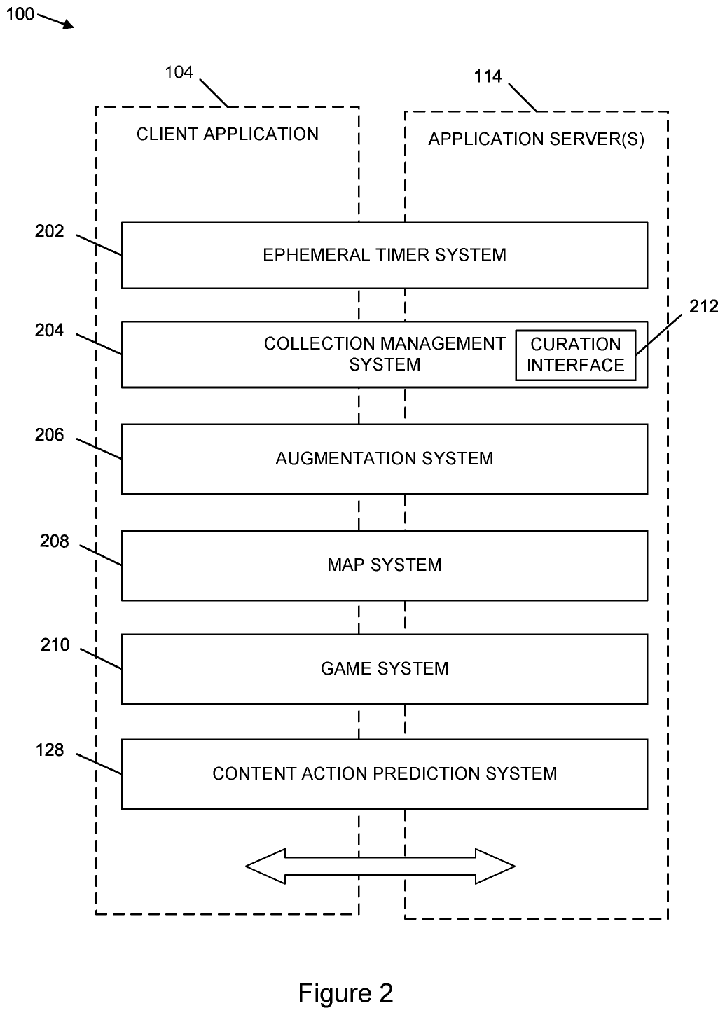

FIG. 2 is a block diagram illustrating further details regarding the server system 108, according to some examples. Specifically, the server system 108 is shown to comprise the client application 104 and the application servers 114. The server system 108 embodies a number of subsystems, which are supported on the client-side by the client application 104 and on the sever-side by the application servers 114. These subsystems include, for example, an ephemeral timer system 202, a collection management system 204, an augmentation system 206, a map system 208, a game system 210, and the content action prediction system 128.

The ephemeral timer system 202 is responsible for enforcing the temporary or time-limited access to content by the client application 104 and the messaging application system 122. The ephemeral timer system 202 incorporates a number of timers that, based on duration and display parameters associated with a message, or collection of messages (e.g., a story), selectively enable access (e.g., for presentation and display) to messages and associated content via the client application 104. Further details regarding the operation of the ephemeral timer system 202 are provided below.

The collection management system 204 is responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 204 may also be responsible for publishing an icon that provides notification of the existence of a particular collection to the user interface of the client application 104.

The collection management system 204 furthermore includes a curation interface 212 that allows a collection manager to manage and curate a particular collection of content. For example, the curation interface 212 enables an event organizer to curate a collection of content relating to a specific event (e.g., delete inappropriate content or redundant messages). Additionally, the collection management system 204 employs machine vision (or image recognition technology) and content rules to automatically curate a content collection. In certain examples, compensation may be paid to a user for the inclusion of user-generated content into a collection. In such cases, the collection management system 204 operates to automatically make payments to such users for the use of their content.

The augmentation system 206 provides various functions that enable a user to augment (e.g., annotate or otherwise modify or edit) media content associated with content produced via the client application 104, such as a message. For example, the augmentation system 206 provides functions related to the generation and publishing of media overlays for content processed by the server system 108. The augmentation system 206 operatively supplies a media overlay or augmentation (e.g., an image filter) to the client application 104 based on a geolocation of the client device 102. In another example, the augmentation system 206 operatively supplies a media overlay to the client application 104 based on other information, such as social network information of the user of the client device 102. A media overlay may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo) at the client device 102. For example, the media overlay may include text or image that can be overlaid on top of a photograph taken by the client device 102. In another example, the media overlay includes an identification of a location overlay (e.g., Venice beach), a name of a live event, or a name of a merchant overlay (e.g., Beach Coffee House). In another example, the augmentation system 206 uses the geolocation of the client device 102 to identify a media overlay that includes the name of a merchant at the geolocation of the client device 102. The media overlay may include other indicia associated with the merchant. The media overlays may be stored in the database(s) 118 and accessed through the database server(s) 116.

In some examples, the augmentation system 206 provides a user-based publication platform that enables users to select a geolocation on a map and upload content associated with the selected geolocation. The user may also specify circumstances under which a particular media overlay should be offered to other users. The augmentation system 206 generates a media overlay that includes the uploaded content and associates the uploaded content with the selected geolocation.

In other examples, the augmentation system 206 provides a merchant-based publication platform that enables merchants to select a particular media overlay associated with a geolocation via a bidding process. For example, the augmentation system 206 associates the media overlay of the highest bidding merchant with a corresponding geolocation for a predefined amount of time.

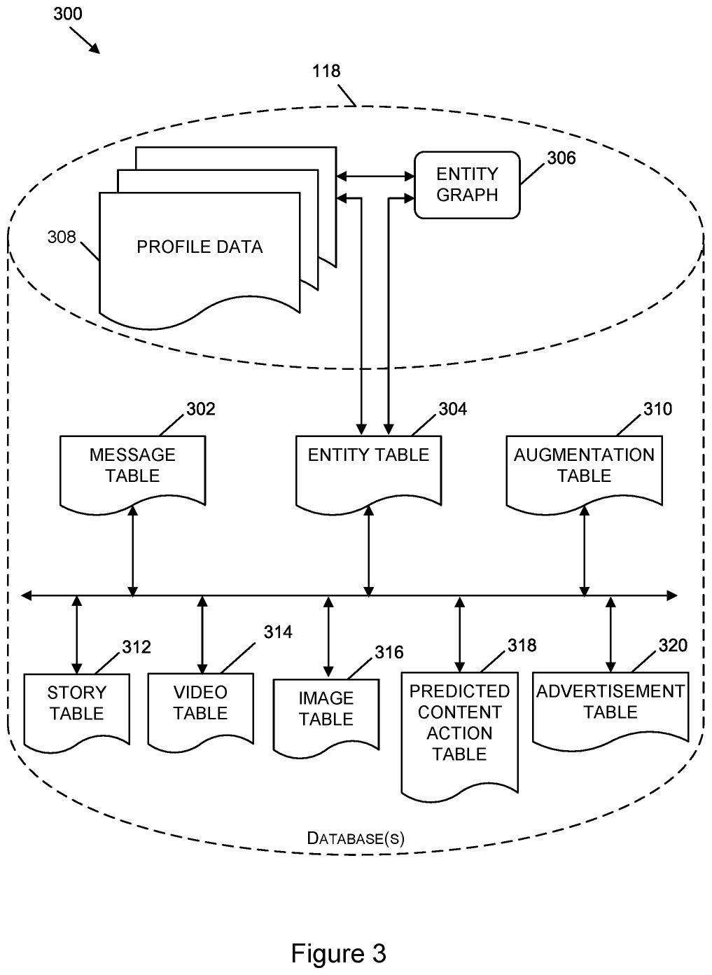

The map system 208 provides various geographic location functions and supports the presentation of map-based media content and messages by the client application 104. For example, the map system 208 enables the display of user icons or avatars (e.g., stored in profile data 308 of FIG. 3) on a map to indicate a current or past location of “friends” of a user, as well as media content (e.g., collections of messages including photographs and videos) generated by such friends, within the context of a map. For example, a message posted by a user to the server system 108 from a specific geographic location may be displayed within the context of a map at that particular location to “friends” of a specific user on a map interface of the client application 104. A user can furthermore share his or her location and status information (e.g., using an appropriate status avatar) with other users of the server system 108 via the client application 104, with this location and status information being similarly displayed within the context of a map interface of the client application 104 to selected users.

The game system 210 provides various gaming functions within the context of the client application 104. The client application 104 provides a game interface providing a list of available games that can be launched by a user within the context of the client application 104 and played with other users of the server system 108. The server system 108 further enables a particular user to invite other users to participate in the play of a specific game, by issuing invitations to such other users from the client application 104. The client application 104 also supports both the voice and text messaging (e.g., chats) within the context of gameplay, provides a leaderboard for the games, and also supports the provision of in-game rewards (e.g., coins and items).

The content action prediction system 128 may include one or more machine learning architectures that analyze profile information of users of the client application 104 to determine probabilities of users performing actions that are related to one or more content items. For a given user, the content action prediction system 128 can identify users that are most likely to interact with one or more content items by performing actions related to the one or more content items. In various examples, the content action prediction system 128 may analyze profile information of a user to determine one or more content items having at least a threshold likelihood of a user performing one or more actions in relation to the one or more content items. The content action prediction system 128 may then operate in conjunction with one or more other systems, such as the collection management system 204, the augmentation system 206, the map system 208, and/or the game system 210, to cause a content item to be accessible to the user of the client application 104.

FIG. 3 is a schematic diagram illustrating data structures 300 which may be stored in the database(s) 118 of the server system 108, according to one or more example implementations. While the content of the database(s) 118 is shown to comprise a number of tables, it will be appreciated that the data could be stored in other types of data structures (e.g., as an object-oriented database).

The database 118 includes message data stored within a message table 302. This message data includes, for any particular one message, at least message sender data, message recipient (or receiver) data, and a payload.

An entity table 304 stores entity data, and is linked (e.g., referentially) to an entity graph 306 and profile data 308. Entities for which records are maintained within the entity table 304 may include individuals, corporate entities, organizations, objects, places, events, and so forth. Regardless of entity type, any entity regarding which the server system 108 stores data may be a recognized entity. Each entity is provided with a unique identifier, as well as an entity type identifier (not shown).

The entity graph 306 stores information regarding relationships and associations between entities. Such relationships may be social, professional (e.g., work at a common corporation or organization) interested-based or activity-based, merely for example.

The profile data 308 stores multiple types of profile data about a particular entity. In one or more examples, the profile data 308 may include at least a portion of the user profile information 132. The profile data 308 may be selectively used and presented to other users of the architecture 100, based on privacy settings specified by a particular entity. Where the entity is an individual, the profile data 308 includes, for example, a username, telephone number, address, settings (e.g., notification and privacy settings), as well as a user-selected avatar representation (or collection of such avatar representations). A particular user may then selectively include one or more of these avatar representations within the content of messages or other data communicated via the architecture 100, and on map interfaces displayed by client application 104 to other users. The collection of avatar representations may include “status avatars,” which present a graphical representation of a status or activity that the user may select to communicate at a particular time.

Where the entity is a group, the profile data 308 for the group may similarly include one or more avatar representations associated with the group, in addition to the group name, members, and various settings (e.g., notifications) for the relevant group.

The database 118 also stores augmentation data, such as overlays or filters, in an augmentation table 310. The augmentation data is associated with and applied to videos (for which data is stored in a video table 314) and images (for which data is stored in an image table 316).

Filters, in one example, are overlays that are displayed as overlaid on an image or video during presentation to a recipient user. Filters may be of various types, including user-selected filters from a set of filters presented to a sending user by the client application 104 when the sending user is composing a message. Other types of filters include geolocation filters (also known as geo-filters), which may be presented to a sending user based on geographic location. For example, geolocation filters specific to a neighborhood or special location may be presented within a user interface by the client application 104, based on geolocation information determined by a Global Positioning System (GPS) unit of the client device 102.

Another type of filter is a data filter, which may be selectively presented to a sending user by the client application 104, based on other inputs or information gathered by the client device 102 during the message creation process. Examples of data filters include current temperature at a specific location, a current speed at which a sending user is traveling, battery life for a client device 102, or the current time.

Other augmentation data that may be stored within the image table 316 includes augmented reality content items (e.g., corresponding to applying Lenses or augmented reality experiences). An augmented reality content item may be a real-time special effect and sound that may be added to an image or a video.

As described above, augmentation data includes augmented reality content items, overlays, image transformations, AR images, and similar terms refer to modifications that may be applied to image data (e.g., videos or images). This includes real-time modifications, which modify an image as it is captured using device sensors (e.g., one or multiple cameras) of a client device 102 and then displayed on a screen of the client device 102 with the modifications. This also includes modifications to stored content, such as video clips in a gallery that may be modified. For example, in a client device 102 with access to multiple augmented reality content items, a user can use a single video clip with multiple augmented reality content items to see how the different augmented reality content items will modify the stored clip. For example, multiple augmented reality content items that apply different pseudorandom movement models can be applied to the same content by selecting different augmented reality content items for the content. Similarly, real-time video capture may be used with an illustrated modification to show how video images currently being captured by sensors of a client device 102 would modify the captured data. Such data may simply be displayed on the screen and not stored in memory, or the content captured by the device sensors may be recorded and stored in memory with or without the modifications (or both). In some systems, a preview feature can show how different augmented reality content items will look within different windows in a display at the same time. This can, for example, enable multiple windows with different pseudorandom animations to be viewed on a display at the same time.

Data and various systems using augmented reality content items or other such transform systems to modify content using this data can thus involve detection of objects (e.g., faces, hands, bodies, cats, dogs, surfaces, objects, etc.), tracking of such objects as they leave, enter, and move around the field of view in video frames, and the modification or transformation of such objects as they are tracked. In various implementations, different methods for achieving such transformations may be used. Some examples may involve generating a three-dimensional mesh model of the object or objects and using transformations and animated textures of the model within the video to achieve the transformation. In other examples, tracking of points on an object may be used to place an image or texture (which may be two dimensional or three dimensional) at the tracked position. In still further examples, neural network analysis of video frames may be used to place images, models, or textures in content (e.g., images or frames of video). Augmented reality content items thus refer both to the images, models, and textures used to create transformations in content, as well as to additional modeling and analysis information needed to achieve such transformations with object detection, tracking, and placement.

Real-time video processing can be performed with any kind of video data (e.g., video streams, video files, etc.) saved in a memory of a computerized system of any kind. For example, a user can load video files and save them in a memory of a device or can generate a video stream using sensors of the device. Additionally, any objects can be processed using a computer animation model, such as a human's face and parts of a human body, animals, or non-living things such as chairs, cars, or other objects.

In some examples, when a particular modification is selected along with content to be transformed, elements to be transformed are identified by the computing device, and then detected and tracked if they are present in the frames of the video. The elements of the object are modified according to the request for modification, thus transforming the frames of the video stream. Transformation of frames of a video stream can be performed by different methods for different kinds of transformation. For example, for transformations of frames mostly referring to changing forms of object's elements characteristic points for each element of an object are calculated (e.g., using an Active Shape Model (ASM) or other known methods). Then, a mesh based on the characteristic points is generated for each of the at least one element of the object. This mesh used in the following stage of tracking the elements of the object in the video stream. In the process of tracking, the mentioned mesh for each element is aligned with a position of each element. Then, additional points are generated on the mesh. A first set of first points is generated for each element based on a request for modification, and a set of second points is generated for each element based on the set of first points and the request for modification. Then, the frames of the video stream can be transformed by modifying the elements of the object on the basis of the sets of first and second points and the mesh. In such method, a background of the modified object can be changed or distorted as well by tracking and modifying the background.

In some examples, transformations changing some areas of an object using its elements can be performed by calculating characteristic points for each element of an object and generating a mesh based on the calculated characteristic points. Points are generated on the mesh, and then various areas based on the points are generated. The elements of the object are then tracked by aligning the area for each element with a position for each of the at least one element, and properties of the areas can be modified based on the request for modification, thus transforming the frames of the video stream. Depending on the specific request for modification properties of the mentioned areas can be transformed in different ways. Such modifications may involve changing color of areas; removing at least some part of areas from the frames of the video stream; including one or more new objects into areas which are based on a request for modification; and modifying or distorting the elements of an area or object. In various implementations, any combination of such modifications or other similar modifications may be used. For certain models to be animated, some characteristic points can be selected as control points to be used in determining the entire state-space of options for the model animation.

In some examples of a computer animation model to transform image data using face detection, the face is detected on an image with use of a specific face detection algorithm (e.g., Viola-Jones). Then, an Active Shape Model (ASM) algorithm is applied to the face region of an image to detect facial feature reference points.

Other methods and algorithms suitable for face detection can be used. For example, in some implementations, features are located using a landmark, which represents a distinguishable point present in most of the images under consideration. For facial landmarks, for example, the location of the left eye pupil may be used. If an initial landmark is not identifiable (e.g., if a person has an eyepatch), secondary landmarks may be used. Such landmark identification procedures may be used for any such objects. In some examples, a set of landmarks forms a shape. Shapes can be represented as vectors using the coordinates of the points in the shape. One shape is aligned to another with a similarity transform (allowing translation, scaling, and rotation) that minimizes the average Euclidean distance between shape points. The mean shape is the mean of the aligned training shapes.

In various examples, a search for landmarks from the mean shape aligned to the position and size of the face determined by a global face detector is started. Such a search then repeats the steps of suggesting a tentative shape by adjusting the locations of shape points by template matching of the image texture around each point and then conforming the tentative shape to a global shape model until convergence occurs. In one or more systems, individual template matches are unreliable, and the shape model pools the results of the weak template matches to form a stronger overall classifier. The entire search is repeated at each level in an image pyramid, from coarse to fine resolution.

A transformation system can capture an image or video stream on a client device (e.g., the client device 102) and perform complex image manipulations locally on the client device 102 while maintaining a suitable user experience, computation time, and power consumption. The complex image manipulations may include size and shape changes, emotion transfers (e.g., changing a face from a frown to a smile), state transfers (e.g., aging a subject, reducing apparent age, changing gender), style transfers, graphical element application, and any other suitable image or video manipulation implemented by a convolutional neural network that has been configured to execute efficiently on the client device 102.

A computer animation model to transform image data can be used by a system where a user may capture an image or video stream of the user (e.g., a selfie) using a client device 102 having a neural network operating as part of a client application 104 operating on the client device 102. The transformation system operating within the client application 104 determines the presence of a face within the image or video stream and provides modification icons associated with a computer animation model to transform image data, or the computer animation model can be present as associated with an interface described herein. The modification icons include changes that may be the basis for modifying the user's face within the image or video stream as part of the modification operation. Once a modification icon is selected, the transform system initiates a process to convert the image of the user to reflect the selected modification icon (e.g., generate a smiling face on the user). A modified image or video stream may be presented in a graphical user interface displayed on the client device 102 as soon as the image or video stream is captured, and a specified modification is selected. The transformation system may implement a complex convolutional neural network on a portion of the image or video stream to generate and apply the selected modification. That is, the user may capture the image or video stream and be presented with a modified result in real-time or near real-time once a modification icon has been selected. Further, the modification may be persistent while the video stream is being captured, and the selected modification icon remains toggled. Machine taught neural networks may be used to enable such modifications.

The graphical user interface, presenting the modification performed by the transform system, may supply the user with additional interaction options. Such options may be based on the interface used to initiate the content capture and selection of a particular computer animation model (e.g., initiation from a content creator user interface). In various implementations, a modification may be persistent after an initial selection of a modification icon. The user may toggle the modification on or off by tapping or otherwise selecting the face being modified by the transformation system and store it for later viewing or browse to other areas of the imaging application. Where multiple faces are modified by the transformation system, the user may toggle the modification on or off globally by tapping or selecting a single face modified and displayed within a graphical user interface. In some implementations, individual faces, among a group of multiple faces, may be individually modified, or such modifications may be individually toggled by tapping or selecting the individual face or a series of individual faces displayed within the graphical user interface.

A story table 312 stores data regarding collections of messages and associated image, video, or audio data, which are compiled into a collection (e.g., a story or a gallery). The creation of a particular collection may be initiated by a particular user (e.g., each user for which a record is maintained in the entity table 304). A user may create a “personal story” in the form of a collection of content that has been created and sent/broadcast by that user. To this end, the user interface of the client application 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from varies locations and events. Users whose client devices have location services enabled and are at a common location event at a particular time may, for example, be presented with an option, via a user interface of the client application 104, to contribute content to a particular live story. The live story may be identified to the user by the client application 104, based on his or her location. The end result is a “live story” told from a community perspective.

A further type of content collection is known as a “location story,” which enables a user whose client device 102 is located within a specific geographic location (e.g., on a college or university campus) to contribute to a particular collection. In some examples, a contribution to a location story may require a second degree of authentication to verify that the end user belongs to a specific organization or other entity (e.g., is a student on the university campus).

As mentioned above, the video table 314 stores video data that, in one example, is associated with messages for which records are maintained within the message table 302. Similarly, the image table 316 stores image data associated with messages for which message data is stored in the entity table 304. The entity table 304 may associate various augmentations from the augmentation table 310 with various images and videos stored in the image table 316 and the video table 314.

The database(s) 118 may also store a predicted content action data table 318. The predicted content action data table 318 may indicate probabilities of users of the client application 104 performing one or more actions in relation to one or more content items. In one or more examples, the predicted content action data table 318 may be accessed periodically to identify one or more content items that are to be accessible to a user of the client application 104. In at least some instances, the one or more content items may include advertisements that are displayed to a user. In various examples, the user may be viewing one or more additional content items, such as messages or social networking content, prior to the advertisements being provided to the user and the predicted content action data table 318 may be accessed to determine one or more advertisements to provide to the user while the user is viewing the one or more additional content items.

Additionally, the database(s) 118 may store an advertisement table 320. The advertisement table 320 may store advertising content items that are provided to users of the client application 104. In one or more examples, the advertisement table 320 may indicate one or more users that correspond to individual advertising content items. In various examples, an advertising content item may correspond to a user of the client application 104 in situations where the user has at least a threshold probability of taking at least one action in relation to the advertising content item. In one or more additional examples, the advertisement table 320 may indicate at least one of one or more content items or one or more classifications of content items that correspond to one or more advertising content items. For example, the advertisement table 320 may indicate one or more advertising content items that may be provided in conjunction with one or more additional content items or one or more classifications of content items. That is, in situations where a user of the client application 104 is accessing a given content item via the client application 104, the advertisement table 320 may indicate one or more advertising content items that may be provided while the user is accessing the given content item. In one or more illustrative examples, one or more first advertising content items may correspond to messaging content, one or more second advertising content items may correspond to social networking content, and one or more third advertising content items may correspond to augmented reality content items.

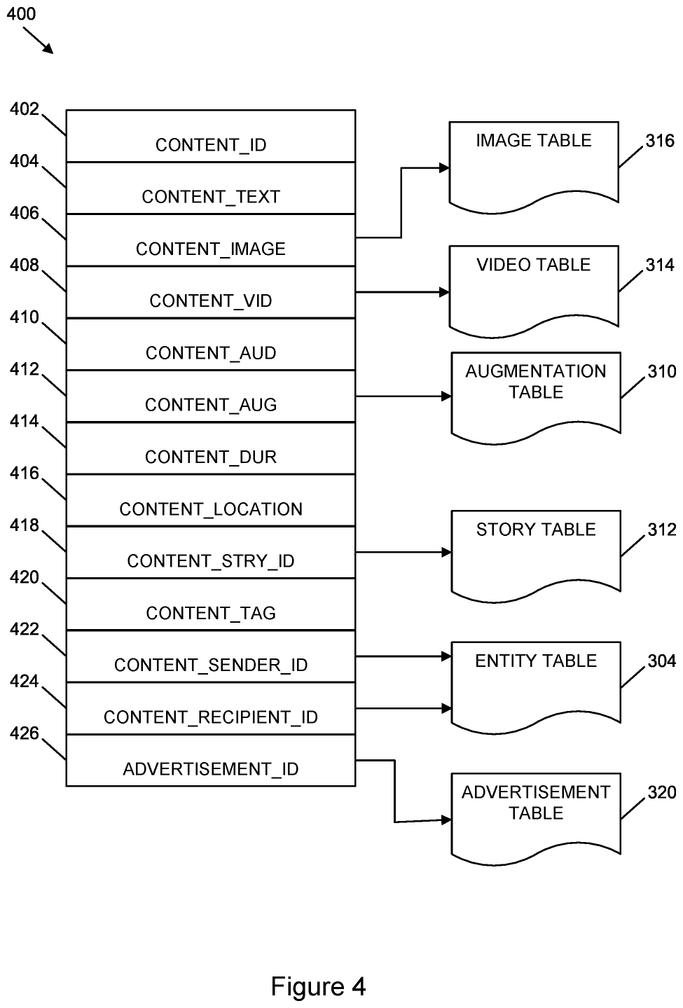

FIG. 4 is a schematic diagram illustrating an example framework for content 400, according to some implementations. The content 400 may be generated by the client application 104. In various examples, the content 400 may be generated by a first instance of the client application 104 and communicated to at least one of a second instance of the client application 104 or the server system 108. In situations where the content 400 includes a message, the content 400 may be used to populate the message table 302 stored within the database(s) 118 and accessible by the application server 114. In one or more implementations, the content 400 may be stored in memory as “in-transit” or “in-flight” data of at least one of client devices 102 or the application server 114. The content 400 is shown to include at least a portion of the following components:
content identifier 402: a unique identifier that identifies the content 400.
content text payload 404: text, to be generated by a user via a user interface of the client device 102, and that is included in the content 400.
content image payload 406: image data, captured by a camera component of a client device 102 or retrieved from a memory component of a client device 102, and that is included in the content 400. Image data for sent or received content 400 may be stored in the image table 316.
content video payload 408: video data, captured by a camera component or retrieved from a memory component of the client device 102, and that is included in the content 400. Video data for sent or received content 400 may be stored in the video table 314.
content audio payload 410: audio data, captured by a microphone or retrieved from a memory component of the client device 102, and that is included in the content 400.
content augmentation data 412: augmentation data (e.g., filters, stickers, or other annotations or enhancements) that represents augmentations to be applied to content image payload 406, content video payload 408, or content audio payload 410 of the content 400. Augmentation data for a sent or received content 400 may be stored in the augmentation table 310.
content duration parameter 414: parameter value indicating, in seconds, the amount of time for which one or more portions of the content 400 (e.g., the content image payload 406, content video payload 408, content audio payload 410) are to be presented or made accessible to a user via the client application 104.
content geolocation parameter 416: geolocation data (e.g., latitudinal and longitudinal coordinates) associated with the content payload of the message. Multiple content geolocation parameter 416 values may be included in the payload, each of these parameter values being associated with respect to content items included in the content (e.g., a specific image into within the content image payload 406, or a specific video in the content video payload 408).
content story identifier 418: identifier values identifying one or more content collections (e.g., “stories” identified in the story table 312) with which a particular item in the content image payload 406 of the content 400 is associated. For example, multiple images within the content image payload 406 may each be associated with multiple content collections using identifier values.
content tag 420: each content 400 may be tagged with multiple tags, each of which is indicative of the subject matter of content included in the content payload. For example, where a particular image included in the content image payload 406 depicts an animal (e.g., a lion), a tag value may be included within the content tag 420 that is indicative of the relevant animal. Tag values may be generated manually, based on user input, or may be automatically generated using, for example, image recognition.
content sender identifier 422: an identifier (e.g., a messaging system identifier, email address, or device identifier) indicative of a user of the client device 102 on which the content 400 was generated and from which the content 400 was sent.
content receiver identifier 424: an identifier (e.g., a messaging system identifier, email address, or device identifier) indicative of a user of the client device 102 to which the content 400 is addressed.
advertisement identifier 426: an identifier related to one or more advertisements that correspond to the content 400. For example, the advertisement identifier 426 may indicate one or more advertisements that may be provided in conjunction with the content 400.

The data (e.g., values) of the various components of content 400 may correspond to pointers to locations in tables within which the data is stored. For example, an image value in the content image payload 406 may be a pointer to (or address of) a location within an image table 316. Similarly, values within the content video payload 408 may point to data stored within a video table 314, values stored within the content augmentations 412 may point to data stored in an augmentation table 310, values stored within the content story identifier 418 may point to data stored in a story table 312, and values stored within the content sender identifier 422 and the content recipient identifier 424 may point to user records stored within an entity table 304. Further, the advertisement identifier 426 may be analyzed with respect to identifiers included in the advertisement table 320 to determine one or more advertising content items that may be provided to a user of the client application 104 in conjunction with the user accessing the content 400.

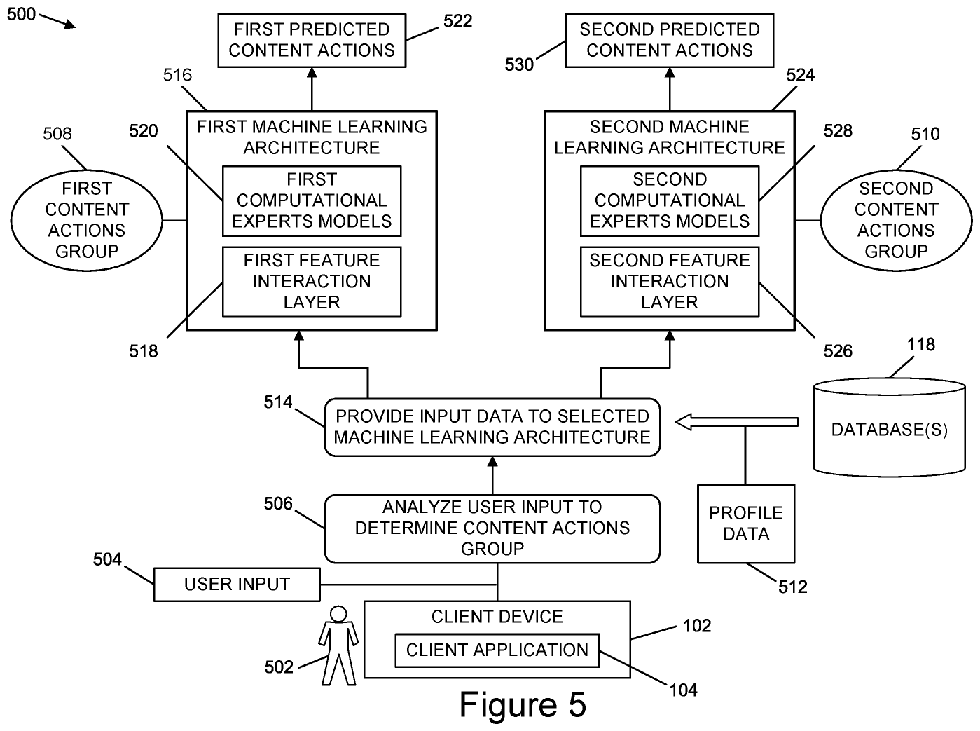

FIG. 5 is a diagrammatic representation illustrating an environment 500 that includes machine learning architectures that are related to respective content action groups and that generate predicted actions for users in relation to content based on input data corresponding to the users, in accordance with one or more example implementations. In one or more examples, at least a portion of the environment 500 may be implemented by the content action prediction system 128 of FIG. 1 and FIG. 2. The environment 500 may include a client device 102 is operated by a user 502. The client device 102 may store and execute an instance of the client application 104. The client device 102 may also include one or more cameras and the one or more cameras may capture at least one of image content or video content. The image or video content captured by the client device 102 may be included in at least one of message content or social networking content that is created by and accessible via the client application 104. In one or more examples, the image content or the video content may be modified by augmented reality content.

User input 504 may be generated by the user 502 in relation to the client application 104 using one or more input devices of the client device 102. The user input 504 may correspond to accessing content via the client application 104. In one or more examples, the user input 504 may correspond to accessing at least one of social networking content or messaging content using the client application 104.

At operation 506, the user input 504 may be analyzed to determine a content actions group that corresponds to the user input 504. In various examples, the user input 504 may correspond to accessing one or more types of content and the content actions group may be determined based on the type of action being performed. The content actions group may correspond to one or more actions that the user 502 may perform with respect to content that is being accessed by the user 502 via the client application 104 and in conjunction with the user input 504. For example, the user input 504 may be analyzed to determine that the user 502 is requesting to share video content with other users of the client application. Additionally, the user input 504 may be analyzed to determine that the user is requesting to modify the video content using one or more augmented reality content items. In one or more examples, a first content actions group 508 may be related to sharing video content by sharing the video content with individual additional users of the client application 104, by including the video content in a social networking post, or by sharing the video content to a collection of content that is accessible to a group of users of the client application 104. With regard to modifying the video content using augmented reality content, a second content actions group 510 may correspond to different augmented reality content items.

In one or more additional examples, the first content actions group 508 and the second content actions group 510 may correspond to advertising content. The user input 504 may be analyzed to determine a type of advertising content to provide to the user 502 via the client application 104. In various examples, the user input 504 may explicitly indicate advertising content that the user 502 is requesting to access. In one or more further examples, the type of advertising content provided to the user 502 via the client application 104 may be based on a classification of content accessed by the user 502 according to the user input 504. In still one or more examples, the type of advertising content provided to the user 502 via the client application 104 may be based on profile data 512 of the user 502.

In one or more illustrative examples, the user input 504 may be analyzed to determine that advertising content related to one or more items available for purchase is to be provided to the user 502 via the client application 104. In these situations, the first content actions group 508 may correspond to viewing a page of an item included in the advertising content, adding an item related to the advertising content to a cart of the user 502 for a potential future purchase of the item, purchasing the item, and performing a sign up process related to an account associated with an item corresponding to the advertising content. In addition, the user input 504 may be analyzed to determine that advertising content related to an additional content application is to be provided to the user 502 via the client application 104. In these scenarios, the second content actions group 510 may include adding the additional client application to a cart of the user 502 in relation to a potential future purchase of the additional client application, purchasing the additional client application, or performing a sign up operation related to an account associated with the additional client application.

In response to determining a content actions group that corresponds to the user input 504, at operation 514, input data may be provided to a machine learning architecture to determine a probability of the user 502 performing one or more actions. In one or more examples, the input data provided to the machine learning architecture may include at least a portion of the profile data 512 of the user 502. The profile data 512 may be analyzed by the machine learning architecture to determine probabilities of the user 502 performing one or more actions included in a content actions group with respect to content that is accessible via the client application 104.

In the illustrative example of FIG. 5, the environment 500 can include a first machine learning architecture 516 that corresponds to the first content actions group 508. The first machine learning architecture 516 may determine individual probabilities of the user 502 performing one or more of the actions included in the first content actions group 508. For example, the first machine learning architecture 516 may analyze the profile data 512 of the user 502 to determine probabilities of the user 502 performing one or more actions included in the first content actions group 508 in regard to content accessible to the user 502 using the client application 104.

The first machine learning architecture 516 may include a first feature extraction layer 518. In one or more illustrative examples, the first feature extraction layer 518 may include a first deep and cross network. The first feature extraction layer 518 may be coupled with one or more first computational experts models 520. The one or more first computational experts models 520 may be included in an extraction layer of the first machine learning architecture 516. In various examples, the one or more first computational experts models 520 may include multiple layers of computational experts models. Individual layers of the multiple layers of computational experts models may include one or more computational experts dedicated to individual actions included in the first content actions group 508. Individual layers of the multiple layers of computational experts models may include one or more shared computational experts models.

The first machine learning architecture 516 may analyze the profile data 512 of the user 502 in relation to the first content actions group 508 to determine first predicted actions 522. The first predicted actions 522 may indicate probabilities for at least a portion of the actions included in the first content actions group 508. The probabilities may be used to rank the actions included in the first content actions group 508. In this way, the first predicted content actions 522 may indicate the likelihood of the user 502 performing individual actions included in the first content actions group 508.

The environment 500 can include a second machine learning architecture 524 that corresponds to the second content actions group 510. The second machine learning architecture 524 may determine individual probabilities of the user 502 performing one or more of the actions included in the second content actions group 510. For example, the second machine learning architecture 524 may analyze the profile data 512 of the user 502 to determine probabilities of the user 502 performing one or more actions included in the second content actions group 510 in regard to content accessible to the user 502 using the client application 104.

The second machine learning architecture 524 may include a second feature extraction layer 526. In one or more illustrative examples, the second feature extraction layer 526 may include a second deep and cross network. The second feature extraction layer 526 may be coupled with one or more second computational experts models 528. The one or more second computational experts models 528 may be included in an extraction layer of the second machine learning architecture 524. In various examples, the one or more second computational experts models 528 may include multiple layers of computational experts models. Individual layers of the multiple layers of computational experts models may include one or more computational experts dedicated to individual actions included in the second content actions group 510. Individual layers of the multiple layers of computational experts models may include one or more shared computational experts models.

The second machine learning architecture 524 may analyze the profile data 512 of the user 502 in relation to the second content actions group 510 to determine second predicted actions 530. The second predicted actions 530 may indicate probabilities for at least a portion of the actions included in the second content actions group 510. The probabilities may be used to rank the actions included in the second content actions group 510. In this way, the second predicted content actions 530 may indicate the likelihood of the user 502 performing individual actions included in the second content actions group 510.

In one or more illustrative examples, the user input 504 may be analyzed at operation 506 to determine that the user input 504 corresponds to accessing content for which advertising content is to be provided. The advertising content may correspond to items that are available for purchase by users of the client application 104. In this illustrative scenario, the operation 506 may determine that the user input 504 corresponds to the first content actions group 508. As a result, at operation 514, the profile data 512 of the user 502 may be provided to the first machine learning architecture 516. For individual advertising content items, the first machine learning architecture 516 may analyze the profile data of the user 502 to determine the first predicted content actions 522. In one or more examples, the first machine learning architecture 516 may determine a first probability that the user 502 will purchase an item, a second probability that the user 502 will add the item to a cart of the user 502 for a potential purchase of the item, a third probability of the user 502 view a page that includes information about the item, and a fourth probability that the user 502 will sign up for an account or for promotional content related to the item. Based on values of the first probability, the second probability, the third probability, and the fourth probability, the first machine learning architecture 516 may rank the actions included in the first content actions group 508 for an individual advertising content item.

In one or more examples, the respective probabilities associated with a number of advertising content items may be analyzed to determine an advertising content item having the highest probabilities and/or highest aggregate probability. The advertising content item may then be provided to the user 502 via the client application 104 based on the likelihood of the user 502 interacting with the advertising content item being higher than the likelihood of the user 502 interaction with other advertising content items.

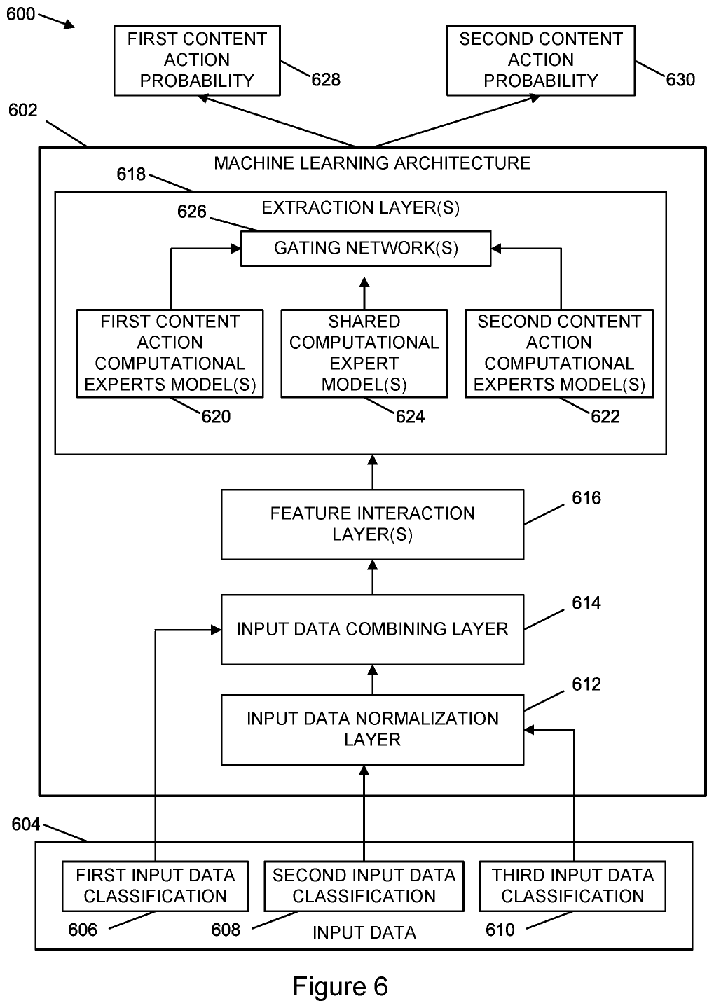

FIG. 6 is a diagrammatic representation illustrative of an environment 600 that includes a machine learning architecture 602 having one or more feature interaction layers coupled with a number of computational experts models to generate predictions indicating actions users may perform with respect to one or more content items, in accordance with one or more example implementations. In one or more illustrative examples, the machine learning architecture 602 may correspond to the first machine learning architecture 516 and the second machine learning architecture 524 of FIG. 5.

The machine learning architecture 602 may obtain input data 604. In one or more examples, the input data 604 may correspond to profile data of a user of a client application. In one or more examples, the input data 604 may correspond to interactions by the user with respect to content that is accessible using the client application. In one or more illustrative examples, the input data 604 may corresponds to interactions by the user with respect to advertising content accessible using the client application. For example, the input data 604 may correspond to a number of advertising content item impressions corresponding to the user over one or more periods of time, such as over 24 hours, 48 hours, 3 days, 4 days, 5 days, 6 days, 7 days, 10 days, or 14 days. In one or more additional examples, the input data 604 may include at least one of identifiers of advertising content items viewed by the user or identifiers of advertising content items selected by the user, such as by swiping or tapping. The input data 604 may also include other content viewing metrics that are related to advertising content items and other content items accessible by the client application. To illustrate, the input data 604 may indicate viewing times over one or more periods of time of one or more classifications of content items by the user via the client application. The input data 604 may also indicate classifications of content accessed by the user via the client application. In further examples, the input data 604 may include demographic information of the user.

The input data 604 may include a number of different types of data. For example, the input data 604 may include data having a first input data classification 606, a second input data classification 608, and a third input data classification 610. The first input data classification 606 may correspond to continuous data that varies and is collected over a period of time. The second input data classification 608 may correspond to discrete data that includes fixed numerical data that may be aggregated by counting. Additionally, the third input data classification 610 may correspond to sparse data that is stored in one or more matrices or arrays having at least a threshold number of elements that are zero. The threshold number may indicate that a majority of elements of a matrix or array are zero.

The machine learning architecture 602 may include an input data normalization layer 612. The input data normalization layer 612 may modify portions of the input data 604 corresponding to the second input data classification 608 and modify portions of the input data 604 corresponding to the third input data classification 610 such that portions of the input data 604 corresponding to the second input data classification 608 and the third input data classification 610 can be combined with portions of the input data 604 that correspond to the first input data classification 606. In at least some implementations, the input data normalization layer 612 may implement one or more lookup tables to normalize the portions of the input data 604 that correspond to the second input data classification 608 and the portions of the input data 604 that correspond to the third input data classification 610. The one or more lookup tables may provide numeric values for portions of the input data 604 that are represented by categories or classifications. In various examples, the input data normalization layer 612 may modify the portions of the input data 604 that correspond to the second input data classification 608 and the portions of the input data 604 that correspond to the third input data classification 610 to have a same format as the portions of the input data 604 that correspond to the first input data classification 606. In one or more examples, the input data normalization layer 612 may include a first set of components to modify the portions of the input data 604 corresponding to the second input data classification 608 and a second set of components to modify portions of the input data 604 corresponding to the third input data classification 610.

The machine learning architecture 602 may include an input data combining layer 614 that combines portions of the input data 604 corresponding to the first input data classification 606 with portions of the input data 604 corresponding to the second input data classification 608 and with portions of the input data 604 corresponding to the third input data classification 610. In one or more illustrative examples, the portions of the input data 604 that correspond to the second input data classification 608 and the portions of the input data 604 that correspond to the third input data classification 610 may be modified by the input data normalization layer 612. As a result, the portions of the input data 604 corresponding to the second input data classification 608 and the portions of the input data 604 corresponding to the third input data classification 610 may be concatenated with the portions of the input data 604 corresponding to the first input data classification 606 by the input data combining layer 614. In one or more examples, the input data combining layer 614 may combine the respective portions of the input data 604 that correspond to the first input data classification 606, the second input data classification 608, and the third input data classification 610 to generate one or more vectors that correspond to the input data 604.

The output from the input data combining layer 614 may be provided to one or more feature interaction layers 616 of the machine learning architecture 602. The one or more feature interaction layers 616 may include one or more deep and cross networks. The one or more deep and cross networks may include a number of cross layers that model explicit features interactions of the input data 604 and one or more deep networks that model implicit feature interactions of the input data 604. In one or more examples, a deep network may be stacked with the one or more cross networks. In one or more additional examples, layers of a deep network can be placed in parallel with the one or more cross networks. In one or more illustrative examples, the cross network may include at least one cross layer, at least two cross layers, at least three cross layers, at least four cross layers, at least five cross layers, at least six cross layers, at least seven cross layers, at least eight cross layers, at least nine cross layers, or at least ten cross layers. In various examples, one or more layer normalization operations may be performed with respect to each layer of the one or more cross networks. The implementation of one or more layer normalization operations with respect to each cross layer may reduce the impact of outlier features and/or features having relatively large values. As a result, the machine learning architecture 602 provides more accurate predictions of user actions than existing architectures. The implementation of a deep and cross network with normalization at the cross layers may also decrease central processing unit usage and latency in relation to existing systems. In one or more examples, the latency of the architecture 600 may be decreased with respect to existing systems at least in part based on using weightings for parameters of the models of the machine learning architecture 602 that are different from weightings used in existing systems. In at least some illustrative examples, the weightings used in relation to parameters of the models included in the one or more feature interaction layers 618 may be different from weightings of parameters used in existing systems.

The output from the one or more feature interaction layers 616 may be obtained by one or more extraction layers 618 included in the machine learning architecture 602. The one or more extraction layers 618 may include a number of computational experts models. In one or more examples, the computational experts models may individually include one or more neural networks. In one or more additional examples, the computational experts models may individually include one or more feed forward neural networks. In various examples, a group of computational experts models may be associated with individual actions being predicted by the machine learning architecture 602. For example, the one or more extraction layers 618 include first content action computational experts models 620 that correspond to a first action that may be performed with respect to content accessible via a client application. In addition, the one or more extraction layers 618 may include second content action computational experts models 622 that correspond to a second action that may be performed with respect to content accessible via a client application. Further, the one or more extraction layers 618 may include one or more shared computational experts models 624 that are shared between the first content action computation experts models 620 and the second content action computational experts models 622. The coupling of the one or more feature interaction layers 616 with the one or more extraction layers 618 result in the machine learning architecture 602 having improved computational resources performance and improved action prediction accuracy in relation to existing systems.

In various examples, the machine learning architecture 602 may include one first content action computational experts model 620, two first content action computational experts models 620, three first content action computational experts models 620, four first content action computational experts models 620, or five first content action computational experts models 620. In addition, the machine learning architecture 602 may include one second content action computational experts model 622, two second content action computational experts models 622, three second content action computational experts models 622, four second content action computational experts models 622, or five second content action computational experts models 622. Further, the machine learning architecture 602 may include one shared computational experts model 624, two shared computational experts model 624, three shared computational experts model 624, four shared computational experts model 624, or five shared computational experts model 624.

The one or more extraction layers 618 may also include one or more gating networks 626. The one or more gating networks 626 may analyze the output from the computational experts models 620, 622, 624 and determine a set of the computational experts models to use to determine a prediction with respect to a content action. In one or more examples, the one or more gating networks 626 may individually include one or more linear transformation functions that are implemented with respect to output from the computational experts models 620, 622, 624. In one or more additional examples, individual gating networks 626 may individually include multiple softmax layers. For example, individual gating networks 626 may include a first softmax layer that generates an output that is provided as input to a second softmax layer.

In situations where the machine learning architecture 602 includes multiple extraction layers 618, individual extraction layers 618 may include a group of computational experts models 620, 622, 624 coupled to respective gating networks 626. For example, the one or more extraction layers 618 may include a first extraction layer having a first number of first content action computational experts models 622, a first number of second content action computational experts models 624, and a first number of shared computational experts models 624. The first extraction layer may also include a first gating network that corresponds to the first number of first content action computational experts models 622 and the shared computational experts models 624, a second gating network that corresponds to the first number of second content action computational experts models 622 and the shared computational experts models 624, and a third gating network that corresponds to the shared computational experts models 624. In these scenarios, the first gating network may generate output that is provided to a second number of first content action computational experts models 620, the second gating network may generate output that is provided to a second number of second content action computational experts models 622, and the third gating network may generate output that is provided to a second number of shared computational experts models 624.

In one or more examples, the number of gating networks 626 in the first extraction layer may correspond to the number of individual groups of computational experts models included in the first extraction layer. Additionally, the number of groups of computational experts models included in the first extraction layer may be the same as the number of groups of computational experts models included in the second extraction layer. In various examples, the number of gating networks 626 included in the second extraction layer may be different from the number of gating networks 626 included in the first extraction layer. To illustrate, the number of gating networks included in the second extraction layer may correspond to the number of content actions for which predictions are being generated. Thus, in the illustrative example of FIG. 6, a second extraction layer may include two gating networks.

Although not shown in the illustrative example of FIG. 6, the machine learning architecture 602 may also include one or more additional computational layers coupled to the gating networks 626 In various examples, the machine learning architecture 602 may include a first additional computational layer that corresponds to prediction of the first content action and a second additional computational layer that corresponds to prediction of the second content action. The one or more additional computational layers coupled to the one or more gating networks 626 may include one or more fully connected layers. In one or more examples, the one or more additional computational layers may transform the output of the one or more gating networks to values corresponding to predictions with respect to the first content action and the second content action. In one or more illustrative examples, the one or more additional computational layers may include linear transforms that transform output from the one or more gating networks 626 to logit values. In various examples, the one or more additional computational layers may include one or more multi-layer perceptron networks.

The machine learning architecture 602 may generate a first content action probability 628 that corresponds to a probability of a user performing a first action with respect to content accessible via a client application. The machine learning architecture 602 may also generate a second content action probability 630 that corresponds to a probability of a user performing a second action with respect to content accessible via the client application. The first content action probability 628 and the second content action probability 630 may be used to determine one or more content items to provide to a user of the client application that corresponds to the input data 604.

Although the illustrative example of FIG. 6 shows that the machine learning architecture 602 generates a first content action probability 628 and a second content action probability 630, in other implementations, the machine learning architecture may generate more content action probabilities or fewer content action probabilities depending on the number of content actions that are included in a content action grouping associated with the respective machine learning architecture. Additionally, the number of computation expert models and the number of gating networks included in the machine learning architecture 602 may also be based on the number of content actions included in a content action grouping associated with the respective machine learning architecture.

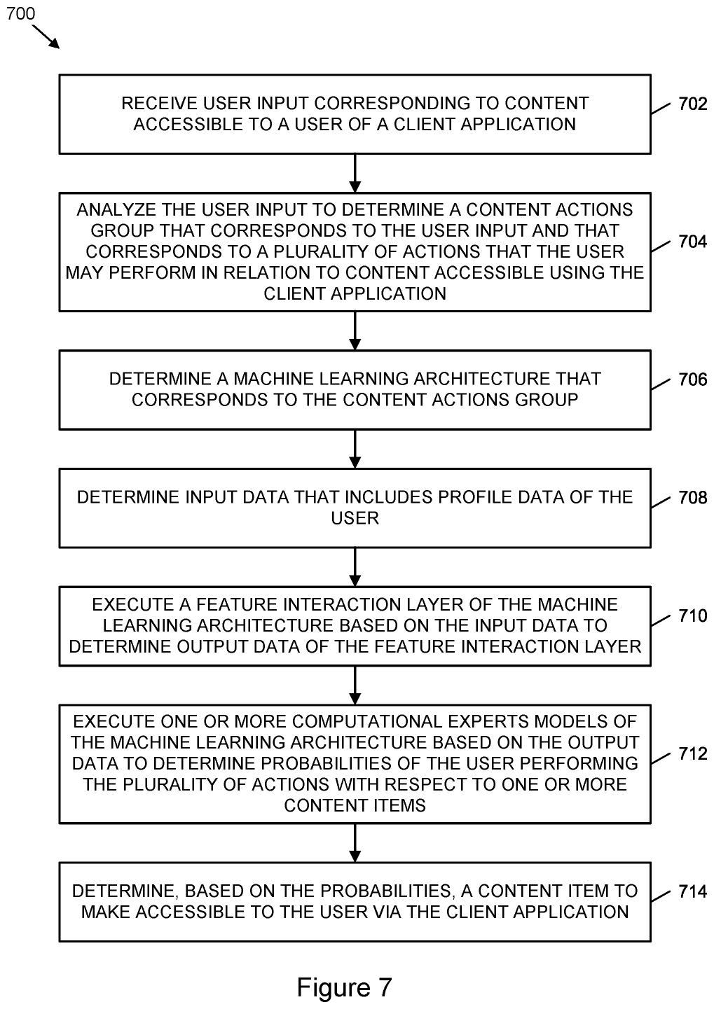

FIG. 7 illustrates flowcharts of processes to predict actions that users may perform with respect to content items accessible via a client application. The processes may be embodied in computer-readable instructions for execution by one or more processors such that the operations of the processes may be performed in part or in whole by the functional components of at least one of the client device 102 or the server system 108. Accordingly, the processes described below are by way of example with reference thereto, in some situations. However, in other implementations, at least some of the operations of the processes described with respect to FIG. 7 may be deployed on various other hardware configurations. The processes described with respect to FIG. 7 are therefore not intended to be limited to the server system 108 or client device 102 and can be implemented in whole, or in part, by one or more additional components. Although the described flowcharts can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

FIG. 7 is a flowchart illustrating example operations of a process 700 to implement one or more machine learning architectures to determine probabilities of users performing actions with respect to content accessible using a client application, according to one or more example implementations. At operation 702, the process 700 may include receiving user input corresponding to content accessible to a user of a client application. In one or more examples, the user input may correspond to content that is being accessed by the user. The user input may indicate selection of the content by the user. The user input may also indicate one or interactions with the content by the user. The content may have one or more characteristics, such as a classification of the content, a creator of the content, one or more recipients of the content, access restrictions to the content, one or more combinations thereof, and the like.

In addition, at operation 704, the process 700 may include analyzing the user input to determine a content actions group that corresponds to the user input. The content actions group may also correspond to a plurality of actions that the user may perform in relation to content accessible using the client application. The content actions group may be one of a plurality of content actions groups. Individual content actions groups of the plurality of content actions groups may correspond to a different set of actions than other content actions groups included in the plurality of content actions groups. In one or more illustrative examples, the content actions group may correspond to actions that may be performed in relation to items available for purchase using the client application. In one or more additional illustrative examples, the content actions group may correspond to actions that may be performed in relation an additional client application that may be obtained and accessed using the client device. In still other illustrative examples, the content actions group may correspond to interactions that users may perform with respect to at least one of video content or augmented reality content, such as an amount of time video content is viewed or a number of times that augmented reality content is executed.

The process 700 may also include, at operation 706, determining a machine learning architecture that corresponds to the content actions group. In one or more examples, individual content actions groups of the plurality of content actions groups may correspond to individual machine learning architectures. For example, a content actions group related to actions that users may perform in relation to items available for purchase via the client application may correspond to a first machine learning architecture that determines probabilities of users performing the actions in association with the items available for purchase. In one or more additional examples, a content actions group related to additional client applications may correspond to a second machine learning architecture that determines probabilities of users performing the actions in association with the additional client applications. The first machine learning architecture and the second machine learning architecture may be training using different training data sets. Additionally, the first machine learning architecture and the second machine learning architecture may include the same or similar components, such as one or more feature interaction layers and one or more computational experts models, but may have different parameters, weights, coefficients, and the like for the various components.

Further, at operation 708, the process 700 may include determining input data that includes profile data of the user. The user profile data may include characteristics of the user. For example, the user profile data may include content viewing history of the user. The user profile data may also include demographic characteristics of the user. Further, the profile data may indicate additional users that the user is connected with and/or frequency of contact with the additional users within the client application. In one or more examples, different machine learning architectures may analyze different portions of the profile data. To illustrate, a first machine learning architecture that corresponds to actions that may be performed by the user with respect to items available for purchase via the client application may analyze a first set of features included in the profile data. Additionally, a second machine learning architecture that corresponds to actions that may be performed with respect to accessing or obtaining additional client applications may analyze a second set of features included in the profile data.

At operation 710, the process 700 may include executing the feature interaction layer of the machine learning architecture based on the input data to determine output data of the feature interaction layer. The feature interaction layer may include a deep and cross network. The deep and cross network may include a plurality of cross layers. In various examples, output from individual cross layers may be normalized before being provided to a subsequent cross layer or to the deep network.

Additionally, the process 700 may include, at operation 712, executing one or more computational experts models of the machine learning architecture based on the output data of the feature interaction layer. The one or more computational experts models may determine probabilities of the user performing the plurality of actions associated with the content actions group with respect to one or more content items. The one or more computational experts models may be included in an extraction layer that is coupled to the feature interaction layer. In various examples, the one or more computational experts models may include feed forward neural networks. The extraction layer may include a set of computational experts models for individual actions of the plurality of actions associated with the content actions group. In this way, individual sets of computational experts models may determine probabilities of users performing an individual action of the plurality of actions of the content actions group. In one or more illustrative examples, the extraction layer may include one or more gating networks that select or combine output from individual computational experts models. The extraction layer may also include one or more shared computational experts models. In one or more examples, the machine learning architecture may include multiple extraction layers with individual extraction layers including a number of groups of computational experts models and one or more gating networks.

In one or more examples, the output of the one or more extraction layers may indicate a first probability of the user performing a first action included in the group of content actions and a second probability of the user performing a second action included in group of content actions. In various examples, the machine learning architecture may determine probabilities of the user performing individual actions included in the group of content actions for a number of content items. For example, a plurality of candidate advertisements may be accessible to the user in relation to the content being accessed by the user. In these situations, the machine learning architecture may determine probabilities of the user performing individual actions included in the group of content actions for individual content items. In at least some examples, the machine learning architecture may determine a ranking or score for the plurality of candidate advertisements based on the probabilities associated with the individual actions included in the content actions group.

The process 700 may also include, at operation 714, determining, based on the probabilities, a content item to make accessible to the user via the client application. In various examples, the probabilities for the group of content actions that correspond to individual content items may be analyzed. The ranking of the content items based on the probabilities may determine a content item to make accessible to the user. The ranking may also be used to determine an order in which content items may be made accessible to the user. That is, content items corresponding to one or more actions with higher probabilities of being performed than other content items may be ranked higher in a ranked list of content items. To illustrate, a first content item may have first probabilities of the user performing one or more actions with respect to the first content item that are greater than second probabilities of the user performing one or more actions with respect to a second content item. In these situations, the first content item may be made accessible to the user instead of the second content item. In one or more additional examples, the first content item may be made accessible to the user before the second content item is made accessible to the user.

The content item may be accessible to the user by displaying the content item to the user via a user interface of the client application or by providing a link to the content item. In various examples, the content item may be made accessible to the user in association with the content that is currently being accessed by the user. In one or more illustrative examples, the content item may include an advertisement. In these scenarios, the advertisement may be displayed in conjunction with additional content that is being viewed by the user, such as at least one of message content or social networking content.

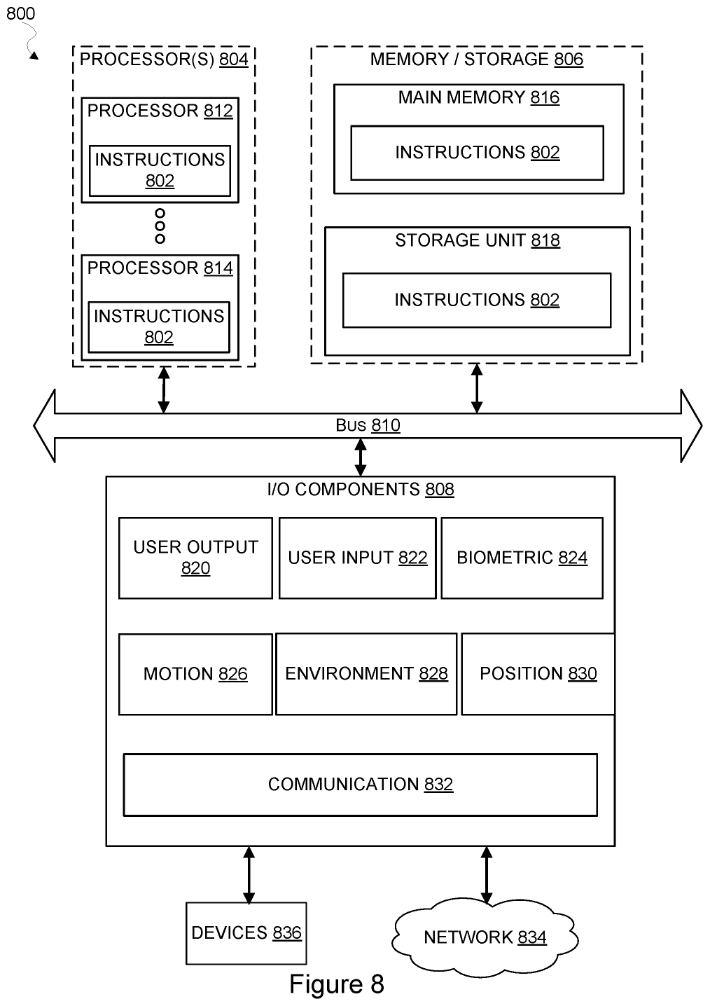

FIG. 8 is a block diagram illustrating components of a machine 800, according to some example implementations, able to read instructions from a machine-readable medium (e.g., a machine-readable storage medium) and perform any one or more of the methodologies discussed herein. Specifically, FIG. 8 shows a diagrammatic representation of the machine 800 in the example form of a computer system, within which instructions 802 (e.g., software, a program, an application, an applet, an app, or other executable code) for causing the machine 800 to perform any one or more of the methodologies discussed herein may be executed. As such, the instructions 802 may be used to implement modules or components described herein. The instructions 802 transform the general, non-programmed machine 800 into a particular machine 800 programmed to carry out the described and illustrated functions in the manner described. In alternative implementations, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 802, sequentially or otherwise, that specify actions to be taken by machine 800. Further, while only a single machine 800 is illustrated, the term “machine” shall also be taken to include a collection of machines that individually or jointly execute the instructions 802 to perform any one or more of the methodologies discussed herein.

The machine 800 may include processors 804, memory/storage 806, and I/O components 808, which may be configured to communicate with each other such as via a bus 810. In an example implementation, the processors 804 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 802. The term “processor” is intended to include multi-core processors 804 that may comprise two or more independent processors (sometimes referred to as “cores”) that may execute instructions 802 contemporaneously. Although FIG. 8 shows multiple processors 804, the machine 800 may include a single processor 812 with a single core, a single processor 812 with multiple cores (e.g., a multi-core processor), multiple processors 812, 814 with a single core, multiple processors 812, 814 with multiple cores, or any combination thereof.

The memory/storage 806 may include memory, such as a main memory 816, or other memory storage, and a storage unit 818, both accessible to the processors 804 such as via the bus 810. The storage unit 818 and main memory 816 store the instructions 802 embodying any one or more of the methodologies or functions described herein. The instructions 802 may also reside, completely or partially, within the main memory 816, within the storage unit 818, within at least one of the processors 804 (e.g., within the processor's cache memory), or any suitable combination thereof, during execution thereof by the machine 800. Accordingly, the main memory 816, the storage unit 818, and the memory of processors 804 are examples of machine-readable media.

The I/O components 808 may include a wide variety of components to receive input, provide output, produce output, transmit information, exchange information, capture measurements, and so on. The specific I/O components 808 that are included in a particular machine 800 will depend on the type of machine. For example, portable machines such as mobile phones will likely include a touch input device or other such input mechanisms, while a headless server machine will likely not include such a touch input device. It will be appreciated that the I/O components 808 may include many other components that are not shown in FIG. 8. The I/O components 808 are grouped according to functionality merely for simplifying the following discussion and the grouping is in no way limiting. In various example implementations, the I/O components 808 may include user output components 820 and user input components 822. The user output components 820 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 822 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instrument), tactile input components (e.g., a physical button, a touch screen that provides location or force of touches or touch gestures, or other tactile input components), audio input components (e.g., a microphone), and the like.

In further example implementations, the I/O components 808 may include biometric components 824, motion components 826, environmental components 828, or position components 830 among a wide array of other components. For example, the biometric components 824 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 826 may include acceleration sensor components (e.g., accelerometer), gravitation sensor components, rotation sensor components (e.g., gyroscope), and so forth. The environmental components 828 may include, for example, illumination sensor components (e.g., photometer), temperature sensor components (e.g., one or more thermometer that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 830 may include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 808 may include communication components 832 operable to couple the machine 800 to a network 834 or devices 836. For example, the communication components 832 may include a network interface component or other suitable device to interface with the network 834. In further examples, communication components 832 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 836 may be another machine 800 or any of a wide variety of peripheral devices (e.g., a peripheral device coupled via a USB).

Moreover, the communication components 832 may detect identifiers or include components operable to detect identifiers. For example, the communication components 832 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 832, such as location via Internet Protocol (IP) geo-location, location via Wi-Fi® signal triangulation, location via detecting an NFC beacon signal that may indicate a particular location, and so forth.

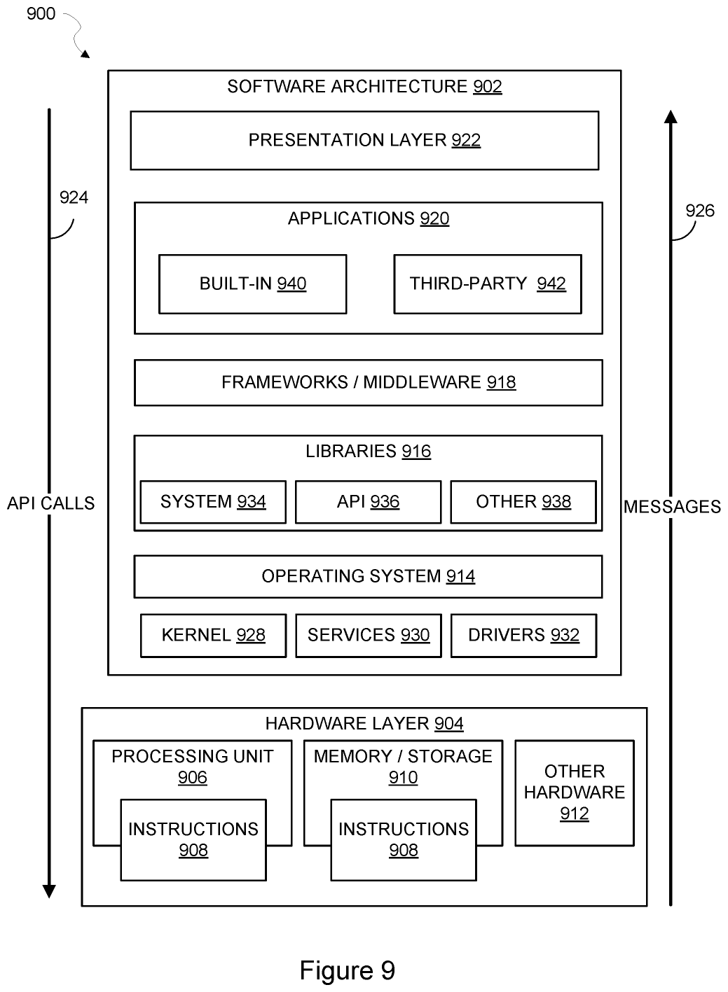

FIG. 9 is a block diagram illustrating system 900 that includes an example software architecture 902, which may be used in conjunction with various hardware architectures herein described. FIG. 9 is a non-limiting example of a software architecture, and it will be appreciated that many other architectures may be implemented to facilitate the functionality described herein. The software architecture 902 may execute on hardware such as machine 800 of FIG. 8 that includes, among other things, processors 804, memory/storage 806, and input/output (I/O) components 808. A representative hardware layer 904 is illustrated and can represent, for example, the machine 800 of FIG. 8. The representative hardware layer 904 includes a processing unit 906 having associated executable instructions 908. Executable instructions 908 represent the executable instructions of the software architecture 902, including implementation of the methods, components, and so forth described herein. The hardware layer 904 also includes at least one of memory or storage modules memory/storage 910, which also have executable instructions 908. The hardware layer 904 may also comprise other hardware 912.

In the example architecture of FIG. 9, the software architecture 902 may be conceptualized as a stack of layers where each layer provides particular functionality. For example, the software architecture 902 may include layers such as an operating system 914, libraries 916, frameworks/middleware 918, applications 920, and a presentation layer 922. Operationally, the applications 920 or other components within the layers may invoke API calls 924 through the software stack and receive messages 926 in response to the API calls 924. The layers illustrated are representative in nature and not all software architectures have all layers. For example, some mobile or special purpose operating systems may not provide a frameworks/middleware 918, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. The drivers 932 are responsible for controlling or interfacing with the underlying hardware. For instance, the drivers 932 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 916 provide a common infrastructure that is used by at least one of the applications 920, other components, or layers. The libraries 916 provide functionality that allows other software components to perform tasks in an easier fashion than to interface directly with the underlying operating system 914 functionality (e.g., kernel 928, services 930, drivers 932). The libraries 916 may include system libraries 934 (e.g., C standard library) that may provide functions such as memory allocation functions, string manipulation functions, mathematical functions, and the like. In addition, the libraries 916 may include API libraries 936 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The frameworks/middleware 918 (also sometimes referred to as middleware) provide a higher-level common infrastructure that may be used by the applications 920 or other software components/modules. For example, the frameworks/middleware 918 may provide various graphical user interface functions, high-level resource management, high-level location services, and so forth. The frameworks/middleware 918 may provide a broad spectrum of other APIs that may be utilized by the applications 920 or other software components/modules, some of which may be specific to a particular operating system 914 or platform.

The applications 920 include built-in applications 940 and third-party applications 942. Examples of representative built-in applications 940 may include, but are not limited to, a contacts application, a browser application, a book reader application, a location application, a media application, a messaging application, or a game application. Third-party applications 942 may include an application developed using the ANDROID™ or IOS™ software development kit (SDK) by an entity other than the vendor of the particular platform and may be mobile software running on a mobile operating system such as IOS™, ANDROID™ WINDOWS® Phone, or other mobile operating systems. The third-party applications 942 may invoke the API calls 924 provided by the mobile operating system (such as operating system 914) to facilitate functionality described herein.

The applications 920 may use built-in operating system functions (e.g., kernel 928, services 930, drivers 932), libraries 916, and frameworks/middleware 918 to create UIs to interact with users of the system. Alternatively, or additionally, in some systems, interactions with a user may occur through a presentation layer, such as presentation layer 922. In these systems, the application/component “logic” can be separated from the aspects of the application/component that interact with a user.

### Glossary

“CARRIER SIGNAL,” in this context, refers to any intangible medium that is capable of storing, encoding, or carrying transitory or non-transitory instructions 802 for execution by the machine 800, and includes digital or analog communications signals or other intangible medium to facilitate communication of such instructions 802. Instructions 802 may be transmitted or received over the network 110, 834 using a transitory or non-transitory transmission medium via a network interface device and using any one of a number of well-known transfer protocols.

“CLIENT DEVICE,” in this context, refers to any machine 800 that interfaces to a communications network 110, 834 to obtain resources from one or more server systems or other client devices 102. A client device 102 may be, but is not limited to, a mobile phone, desktop computer, laptop, PDAs, smart phones, tablets, ultra books, netbooks, laptops, multi-processor systems, microprocessor-based or programmable consumer electronics, game consoles, set-top boxes, or any other communication device that a user may use to access a network 110, 834.

“COMMUNICATIONS NETWORK,” in this context, refers to one or more portions of a network 110, 834 that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network 110, 834 or a portion of a network may include a wireless or cellular network and the coupling may be a Code Division Multiple Access (CDMA) connection, a Global System for Mobile communications (GSM) connection, or other type of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

“EPHEMERAL MESSAGE,” in this context, refers to a message that is accessible for a time-limited duration. An ephemeral message may be a text, an image, a video, and the like. The access time for the ephemeral message may be set by the message sender. Alternatively, the access time may be a default setting, or a setting specified by the recipient. Regardless of the setting technique, the message is transitory.

“MACHINE-READABLE MEDIUM,” in this context, refers to a component, device, or other tangible media able to store instructions 802 and data temporarily or permanently and may include, but is not limited to, random-access memory (RAM), read-only memory (ROM), buffer memory, flash memory, optical media, magnetic media, cache memory, other types of storage (e.g., erasable programmable read-only memory (EEPROM)) and/or any suitable combination thereof. The term “machine-readable medium” may be taken to include a single medium or multiple media (e.g., a centralized or distributed database, or associated caches and servers) able to store instructions 802. The term “machine-readable medium” shall also be taken to include any medium, or combination of multiple media, that is capable of storing instructions 802 (e.g., code) for execution by a machine 800, such that the instructions 802, when executed by one or more processors 804 of the machine 800, cause the machine 800 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se.

“COMPONENT,” in this context, refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various example implementations, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein.

A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an ASIC. A hardware component may also include programmable logic or circuitry that is temporarily configured by software to perform certain operations. For example, a hardware component may include software executed by a general-purpose processor 804 or other programmable processor. Once configured by such software, hardware components become specific machines (or specific components of a machine 800) uniquely tailored to perform the configured functions and are no longer general-purpose processors 804. It will be appreciated that the decision to implement a hardware component mechanically, in dedicated and permanently configured circuitry, or in temporarily configured circuitry (e.g., configured by software) may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering implementations in which hardware components are temporarily configured (e.g., programmed), each of the hardware components need not be configured or instantiated at any one instance in time. For example, where a hardware component comprises a general-purpose processor 804 configured by software to become a special-purpose processor, the general-purpose processor 804 may be configured as respectively different special-purpose processors (e.g., comprising different hardware components) at different times. Software accordingly configures a particular processor 812, 814 or processors 804, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In implementations in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output.

Hardware components may also initiate communications with input or output devices, and can operate on a resource (e.g., a collection of information). The various operations of example methods described herein may be performed, at least partially, by one or more processors 804 that are temporarily configured (e.g., by software) or permanently configured to perform the relevant operations. Whether temporarily or permanently configured, such processors 804 may constitute processor-implemented components that operate to perform one or more operations or functions described herein. As used herein, “processor-implemented component” refers to a hardware component implemented using one or more processors 804. Similarly, the methods described herein may be at least partially processor-implemented, with a particular processor 812, 814 or processors 804 being an example of hardware. For example, at least some of the operations of a method may be performed by one or more processors 804 or processor-implemented components. Moreover, the one or more processors 804 may also operate to support performance of the relevant operations in a “cloud computing” environment or as a “software as a service” (SaaS). For example, at least some of the operations may be performed by a group of computers (as examples of machines 800 including processors 804), with these operations being accessible via a network 110 (e.g., the Internet) and via one or more appropriate interfaces (e.g., an API). The performance of certain of the operations may be distributed among the processors, not only residing within a single machine 800, but deployed across a number of machines. In some example implementations, the processors 804 or processor-implemented components may be located in a single geographic location (e.g., within a home environment, an office environment, or a server farm). In other example implementations, the processors 804 or processor-implemented components may be distributed across a number of geographic locations.

“PROCESSOR,” in this context, refers to any circuit or virtual circuit (a physical circuit emulated by logic executing on an actual processor 804) that manipulates data values according to control signals (e.g., “commands,” “op codes,” “machine code,” etc.) and which produces corresponding output signals that are applied to operate a machine 800. A processor 804 may, for example, be a CPU, a RISC processor, a CISC processor, a GPU, a DSP, an ASIC, a RFIC or any combination thereof. A processor 804 may further be a multi-core processor having two or more independent processors 804 (sometimes referred to as “cores”) that may execute instructions 802 contemporaneously.

“TIMESTAMP,” in this context, refers to a sequence of characters or encoded information identifying when a certain event occurred, for example giving date and time of day, sometimes accurate to a small fraction of a second.

Changes and modifications may be made to the disclosed implementations without departing from the scope of the present disclosure. These and other changes or modifications are intended to be included within the scope of the present disclosure, as expressed in the following claims.

What is claimed is:

1. A method comprising:
receiving, by a computing system that includes one or more processors and memory, user input corresponding to content accessible to a user of a client application;
analyzing, by the computing system, the user input to determine a content actions group that corresponds to the user input, the content actions group including a plurality of actions that users of the client application perform in relation to content accessible by the client application;
determining, by the computing system, a machine learning architecture that corresponds to the content actions group, the machine learning architecture including a feature extraction layer and one or more computational experts models;
determining, by the computing system and based on the content actions group, input data for the machine learning architecture, the input data including profile data of the user;
executing, by the computing system, the feature extraction layer based on the input data to determine output data of the feature extraction layer;
executing, by the computing system and based on the output data of the feature extraction layer, the one or more computational experts models to determine first probabilities of the user performing the plurality of actions with respect to a first content item;
executing, by the computing system, the one or more computational experts models to determine second probabilities of the user performing the plurality of actions with respect to a second content item;
determining, by the computing system, that the first probabilities are greater than the second probabilities; and
causing, by the computing system, the first content item to be accessible to the user via the client application.

2. The method of claim 1, comprising:
determining, by the computing system, one or more characteristics of the content accessible to the user;
determining, by the computing system, a number of candidate advertising content items to make accessible to the user based on the one or more characteristics, wherein the first content item is a first advertising content item of the number of candidate advertising content items and the second content item is a second advertising content item of the number of candidate advertising content items; and
causing, by the computing system, the first advertising content item to be displayed in conjunction with the content.

3. The method of claim 1, wherein:
the machine learning architecture is one of a plurality of machine learning architectures;
the content actions group is one of a plurality of content actions groups that are associated with content items; and
individual machine learning architectures of the plurality of machine learning architectures corresponding to an individual content actions group of the plurality of content action groups.

4. The method of claim 3, comprising:
performing, by the computing system, a first training process of a first machine learning architecture of the plurality of machine learning architectures using a first set of training data, the first set of training data including one or more first characteristics of profile data of users of the client application; and
performing, by the computing system, a second training process of a second machine learning architecture of the plurality of machine learning architectures using a second set of training data, the second set of training data including one or more second characteristics of profile data of users of the client application, the one or more second characteristics being different from the one or more first characteristics.

5. The method of claim 4, wherein the machine learning architecture is a first machine learning architecture, and the method comprises:
extracting, by the computing system, the one or more first characteristics from profile data of the user from a database; and
analyzing, by the computing system and using the first machine learning architecture, values of the one or more first characteristics included in the profile data of the user to determine the first probabilities and the second probabilities.

6. The method of claim 1, wherein the input data includes first data that corresponds to continuous data, second data that corresponds to discrete values, and third data that corresponds to sparse data, the sparse data corresponding to a set of data values with a majority of the set of data values being zero.

7. The method of claim 6, comprising:
performing, by the computing system, a first normalization process with respect to the second data to produce modified second data;
performing, by the computing system, a second normalization process with respect to the third data to produce modified third data;
combining, by the computing system, the first data, the modified second data, and the modified third data to produce modified input data; and
providing, by the computing system, the modified input data to the feature extraction layer.

8. A computing system comprising:
one or more hardware processors; and
one or more non-transitory computer-readable storage media including computer-readable instructions that, when executed by the one or more hardware processors, cause the one or more hardware processors to perform operations comprising:
receiving user input corresponding to content accessible to a user of a client application;
analyzing the user input to determine a content actions group that corresponds to the user input, the content actions group including a plurality of actions that users of the client application perform in relation to content accessible by the client application;
determining a machine learning architecture that corresponds to the content actions group, the machine learning architecture including a feature extraction layer and one or more computational experts models;
determining, based on the content actions group, input data for the machine learning architecture, the input data including profile data of the user;
executing the feature extraction layer based on the input data to determine output data of the feature extraction layer;
executing, based on the output data of the feature extraction layer, the one or more computational experts models to determine probabilities of the user performing the plurality of actions with respect to one or more content items; and
determining, based on the probabilities, a content item of the one or more content items to make accessible to the user via the client application.

9. The computing system of claim 8, wherein the feature extraction layer includes a deep and cross network having a plurality of cross layers coupled to a deep network.

10. The computing system of claim 9, wherein the one or more non-transitory computer-readable storage media including additional computer-readable instructions that, when executed by the one or more hardware processors, cause the one or more hardware processors to perform additional operations comprising:
performing one or more normalization processes with respect to data output from individual cross layers of the plurality of cross layers.

11. The computing system of claim 8, wherein the machine learning architecture includes one or more extraction layers, the one or more extraction layers including the one or more computational experts models.

12. The computing system of claim 11, wherein the one or more extraction layers include:
a first extraction layer having one or more first computational experts models that correspond to a first content action of the plurality of actions, one or more second computational experts models that correspond to a second content action of the plurality of actions, and one or more shared computational experts models; and
a second extraction layer having one or more first additional computational experts models that correspond to the first content action, one or more second additional computational experts models that correspond to the second content action, and one or more additional shared computational experts models.

13. The computing system of claim 12, wherein:
the first extraction layer includes a first gating network coupled to the one or more first computational experts models, a second gating network coupled to the one or more second computational experts models, and a third gating network coupled to the one or more shared computational experts models; and
the second extraction layer includes a first additional gating network coupled to the one or more first additional computational experts models and a second additional gating network coupled to the one or more second additional computational experts model.

14. The computing system of claim 13, wherein the machine learning architecture includes:
a first additional computational layer coupled to the first additional gating network to modify output of the first additional gating network; and
a second additional computational layer coupled to the second additional gating network to modify output of the second additional gating network.

15. The computing system of claim 14, wherein:
the first additional computational layer applies one or more first linear transforms to the output of the first additional gating network to determine first probabilities corresponding to the first content action; and
the second additional computational layer applies one or more second linear transforms to the output of the second additional gating network to determine second probabilities corresponding to the second content action.

16. The computing system of claim 15, wherein the one or more first linear transforms produce one or more first logit values, and the one or more second linear transforms produce one or more second logit values.

17. One or more non-transitory computer-readable storage media including computer-readable instructions that, when executed by one or more hardware processors, cause the one or more hardware processors to perform operations comprising:
receiving user input corresponding to content accessible to a user of a client application;
analyzing the user input to determine a content actions group that corresponds to the user input, the content actions group including a plurality of actions that users of the client application perform in relation to content accessible by the client application;
determining a machine learning architecture that corresponds to the content actions group, the machine learning architecture including a feature extraction layer and one or more computational experts models;
determining, based on the content actions group, input data for the machine learning architecture, the input data including profile data of the user;
executing the feature extraction layer based on the input data to determine output data of the feature extraction layer;
executing, based on the output data of the feature extraction layer, the one or more computational experts models to determine probabilities of the user performing the plurality of actions with respect to one or more content items; and
determining, based on the probabilities, a content item of the one or more content items to make accessible to the user via the client application.

18. The one or more non-transitory computer-readable storage media of claim 17, wherein:
the one or more computational experts models include one or more feed forward neural networks;
the one or more computational experts models are coupled to one or more gating networks; and
the one or more gating networks include a plurality of softmax layers.

19. The one or more non-transitory computer-readable storage media of claim 17, wherein the machine learning architecture includes;
one or more extraction layers that include the one or more computational experts models and one or more gating networks coupled to the one or more computational experts models; and
one or more additional computational layers that are coupled to the one or more gating networks, wherein the one or more additional computational layers determine the probabilities based on output obtained from the one or more gating networks.

20. The one or more non-transitory computer-readable storage media of claim 17, wherein:
the input data includes at least one of information indicating content viewing history of the user or demographic information of the user;
the content item includes advertising content related to an item available for purchase via the client application; and
the plurality of actions includes viewing a page related to the item, purchasing the item, adding the item to a cart of the user for a potential future purchase of the item, and performing a sign up action with regard to the item.
